(19) United States
(12) Patent Application Publication
(10) Pub. No.: US 2026/0074827 A1
(43) Pub. Date: Mar. 12, 2026

(54) METHODS, SYSTEMS, AND APPARATUS FOR BIT VALUE PLACEMENT IN POLAR CODING

(71) Applicant: Huawei Technologies Co., Ltd., Shenzhen (CN)

(72) Inventors: Huazi Zhang, Hangzhou (CN); Jun Wang, Hangzhou (CN); Wen Tong, Ottawa (CA); Yiqun Ge, Ottawa (CA)

(21) Appl. No.: 19/335,764

(22) Filed: Sep. 22, 2025

Related U.S. Application Data
(63) Continuation of application No. PCT/CN2023/083348, filed on Mar. 23, 2023.

(51) Int. Cl. H04L 1/00

(52) U.S. Cl. CPC H04L 1/0057

(57) ABSTRACT

Polar codes for wireless communications are constructed to adapt to channel conditions. Input bits are encoded by a polar code to obtain encoded bits, and the encoded bits are decoded to obtain decoded input bits. The polar code provides or includes bit indices for placing values of the input bits before encoding. The bit indices include a first set of bit indices for placing values of a first subset of the input bits, a second set of bit indices for placing values of a second subset of the input bits, and a third set of bit indices for placing a predetermined bit value. Each value of the first subset of the input bits is placed on one bit index of the first set of bit indices, and each value of the second subset of the input bits is placed on two or more bit indices of the second set of bit indices.

### CROSS-REFERENCE TO RELATED APPLICATION

The present application is a continuation of International Application No. PCT/CN2023/083348, entitled “METHODS, SYSTEMS, AND APPARATUS FOR BIT VALUE PLACEMENT IN POLAR CODING” and filed on Mar. 23, 2023, the disclosure of which is hereby incorporated by reference in its entirety.

### TECHNICAL FIELD

The present application relates to coding, and in particular to placement of bit values on bit indices in polar coding.

### BACKGROUND

In wireless communications, channel conditions are constantly changing at both fast and slow scale due to, for example, fading effects. Accordingly, channel coding has conventionally always been designed to adapt to channel conditions. Modulation and coding scheme (MCS) adaptation, in which the modulation order, code length, and code rate can be changed in real time, is a powerful approach to combat varying channel conditions.

Adapting to channel conditions requires use of channel coding that can flexibly change code length and code rate in a fine-grained way, and at the same time achieve good error correction performance in all possible configurations. This fine-grained flexibility of channel codes remains a challenge.

Probabilistic codes such as low density parity check (LDPC) codes, which are more like random codes, may be naturally suited for flexibility. However, algebraic codes such as Reed-Muller (RM) codes and Bose-Chaudhuri-Hocquenghem (BCH) codes, are not as flexible as probabilistic codes. This is because their inherent coding structures may be compromised when code length or rate changes. Polar codes exhibit features from both probabilistic codes and algebraic codes. As a result, polar codes have a level of flexibility that lies between probabilistic codes and algebraic codes.

Rate matching, including techniques such as puncturing and shortening, are techniques for implementing rate-compatible polar codes, such as the polar codes used in the fifth generation (5G) new radio (NR) 3GPP standard. However, the degree of flexibility afforded by conventional approaches to polar code rate matching is insufficient for supporting more advanced communications features, such as fine-grained incremental-redundancy hybrid automatic repeat request (IR-HARQ), for example.

A more flexible channel coding approach is needed.

### SUMMARY

The present disclosure encompasses embodiments related to bit value placement in polar coding. Embodiments as disclosed herein may be useful, for example, in providing such features as any one or more of: coupling shorter codes or code blocks together, enabling self-decodability of shorter codes or code blocks, and a check-type function between information bits.

According to an aspect of the present disclosure, a method involves encoding input bits by a polar code to obtain encoded bits, and outputting the encoded bits. The polar code comprises bit indices for placing values of the input bits before encoding, and the bit indices include: a first set of bit indices for placing values of a first subset of the input bits, a second set of bit indices for placing values of a second subset of the input bits, and a third set of bit indices for placing a predetermined bit value. Each value of the first subset of the input bits is placed on one bit index of the first set of bit indices, and each value of the second subset of the input bits is placed on two or more bit indices of the second set of bit indices.

Another method involves receiving encoded bits and decoding the encoded bits to obtain decoded input bits. The received encoded bits have been encoded by a polar code that comprises bit indices for placing values of input bits before encoding. The bit indices include: a first set of bit indices for placing values of a first subset of the input bits, a second set of bit indices for placing values of a second subset of the input bits, and a third set of bit indices for a predetermined bit value. Each value of the first subset of the input bits has been placed on one bit index of the first set of bit indices, and each value of the second subset of the input bits has been placed on two or more bit indices of the second set of bit indices.

An apparatus according to an embodiment includes an encoder and an interface. The encoder is for encoding input bits by a polar code to obtain encoded bits, and the interface is coupled to the encoder, for outputting the encoded bits. The polar code comprises bit indices for placing values of the input bits before encoding, and the bit indices include a first set of bit indices for placing values of a first subset of the input bits, a second set of bit indices for placing values of a second subset of the input bits, and a third set of bit indices for placing a predetermined bit value. Each value of the first subset of the input bits is placed on one bit index of the first set of bit indices, and each value of the second subset of the input bits is placed on two or more bit indices of the second set of bit indices.

According to another embodiment, an apparatus includes an interface for encoded bits that have been encoded by a polar code, and a decoder coupled to the interface, for decoding the encoded bits to obtain decoded input bits. As in other embodiments, the polar code comprises bit indices for placing values of input bits before encoding, and the bit indices include a first set of bit indices for placing values of a first subset of the input bits, a second set of bit indices for placing values of a second subset of the input bits, and a third set of bit indices for a predetermined bit value. Each value of the first subset of the input bits has been placed on one bit index of the first set of bit indices, and each value of the second subset of the input bits has been placed on two or more bit indices of the second set of bit indices

In other apparatus embodiments, an apparatus may include a processor configured to cause the apparatus to perform a method as disclosed herein.

An apparatus may include a processor and a non-transitory computer readable storage medium that is coupled to the processor and stores programming for execution by the processor.

A storage medium need not necessarily or only be implemented in or in conjunction with such an apparatus. A computer program product, for example, may be or include a non-transitory computer readable medium storing programming for execution by a processor.

Programming stored by a computer readable storage medium may include instructions to, or to cause a processor to, perform, implement, support, or enable any of the methods disclosed herein.

For example, the programming may include instructions to or to cause a processor to encode input bits by a polar code to obtain encoded bits, and output the encoded bits. The polar code, as in other embodiments, comprises bit indices for placing values of the input bits before encoding, and the bit indices include a first set of bit indices for placing values of a first subset of the input bits, a second set of bit indices for placing values of a second subset of the input bits, and a third set of bit indices for placing a predetermined bit value. Each value of the first subset of the input bits is placed on one bit index of the first set of bit indices, and each value of the second subset of the input bits is placed on two or more bit indices of the second set of bit indices.

In another embodiment, programming includes instructions to or to cause a processor to receive encoded bits that have been encoded by a polar code, and decode the encoded bits to obtain decoded input bits. The polar code comprises bit indices for placing values of input bits before encoding. The bit indices include a first set of bit indices for placing values of a first subset of the input bits, a second set of bit indices for placing values of a second subset of the input bits, and a third set of bit indices for a predetermined bit value. Each value of the first subset of the input bits has been placed on one bit index of the first set of bit indices, and each value of the second subset of the input bits has been placed on two or more bit indices of the second set of bit indices.

A system is also disclosed, and may include a first communication device configured to transmit encoded bits that have been encoded by a polar code, and a second communication device configured to receive the encoded bits from the first communication device and to decode the encoded bits to obtain decoded input bits. The polar code comprises bit indices for placing values of input bits before encoding, and the bit indices include a first set of bit indices for placing values of a first subset of the input bits, a second set of bit indices for placing values of a second subset of the input bits, and a third set of bit indices for a predetermined bit value. Each value of the first subset of the input bits has been placed on one bit index of the first set of bit indices, and each value of the second subset of the input bits has been placed on two or more bit indices of the second set of bit indices.

The present disclosure encompasses these and other aspects or embodiments.

### BRIEF DESCRIPTION OF THE DRAWINGS

For a more complete understanding of the present embodiments, and the advantages thereof, reference is now made, by way of example, to the following descriptions taken in conjunction with the accompanying drawings.

FIG. 1 is a simplified schematic illustration of a communication system.

FIG. 2 is a block diagram illustration of the example communication system in FIG. 1.

FIG. 3 illustrates an example electronic device and examples of base stations.

FIG. 4 illustrates units or modules in a device.

FIG. 5 is a trellis graph illustrating an example of a polar code.

FIG. 6A is a block diagram illustrating an apparatus according to an embodiment.

FIG. 6B is a block diagram illustrating bit value placement on bit indices according to an embodiment.

FIG. 6C is a block diagram illustrating example bit index to label mappings.

FIG. 6D is a block diagram illustrating bit value placement on bit indices, using bit labeling according to an embodiment.

FIG. 7 is a block diagram illustrating code coupling according to an embodiment.

FIG. 8 is a block diagram illustrating code coupling according to another embodiment.

FIG. 9 is a block diagram illustrating code coupling with recursive bit value placement, according to an embodiment.

FIG. 10 is a block diagram illustrating code coupling with recursive bit placement, according to a further embodiment.

FIG. 11 is a block diagram illustrating bit value placement according to an embodiment.

FIG. 12 is a block diagram illustrating bit value placement according to an embodiment.

FIG. 13 is a block diagram illustrating bit value placement according to another embodiment.

FIG. 14 is a block diagram illustrating an example trellis graph and several features according to embodiments disclosed herein.

FIG. 15 is a flow diagram illustrating more general example methods according to embodiments.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

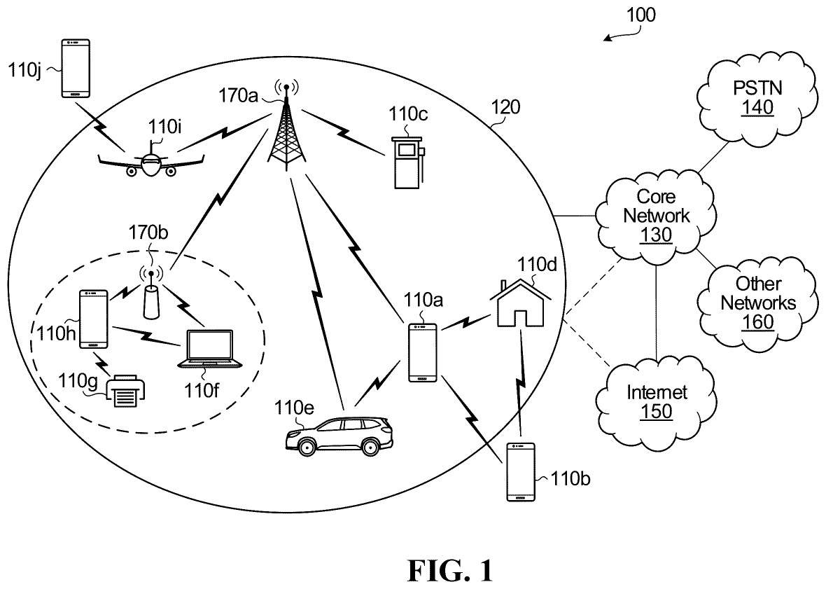

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

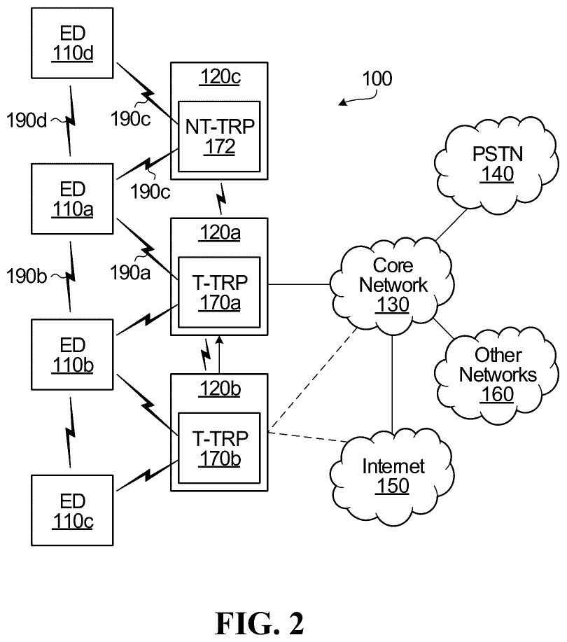

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED no may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

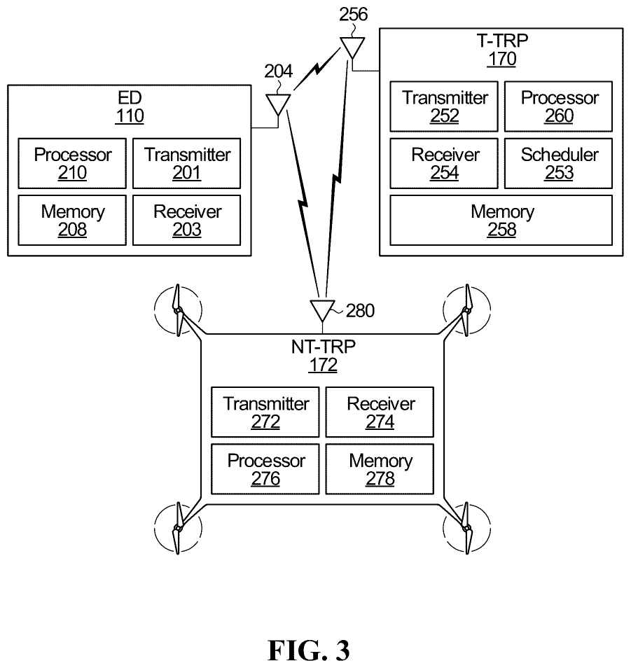

FIG. 3 illustrates another example of an ED no and a base station 170a, 170b and/or 170c. The ED no is used to connect persons, objects, machines, etc. The ED no may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED no represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED no connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

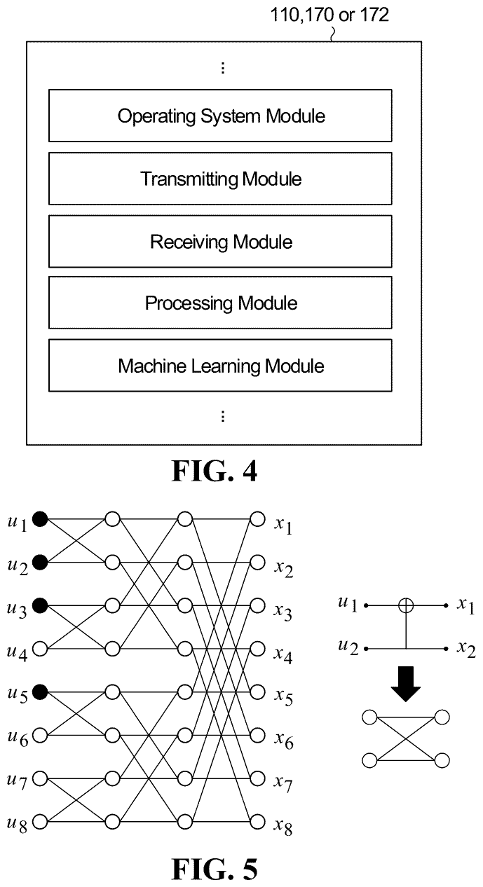

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

Having considered communications more generally above, attention will now turn to particular example embodiments.

Successive cancellation (SC) is the basic decoding algorithm for polar codes. In SC decoding, all frozen bits and information bits are decoded sequentially, bit by bit, according to a defined decoding order of the polar code. By convention, the decoding order is the natural order of the polar code bit indices on which all frozen bits and information bits are placed. Thus, this conventional decoding order is known as “natural order”. Preceding bits of the natural order are always decoded first, before decoding a current bit.

Successive cancellation list (SCL) is an enhanced decoding algorithm for polar codes, where multiple (L) SC decoding instances are executed. Each instance is called a “decoding path”. When decoding each binary bit, both “0” and “1” branches are extended to each path, creating 2L paths. Then, all 2L paths are compared, where the most likely L paths are kept, and the least likely L paths are discarded (or pruned). The path extension and pruning operations are performed during decoding every information bit, until all information bits are decoded. At last, the most likely path is selected as the decoding output.

CRC-aided successive cancellation list (CA-SCL) decoding works almost the same as SCL, except that in the last step, the most likely path that passes CRC check is selected as the decoding output.

Parity-check successive cancellation list (PC-SCL) decoding also works almost the same as SCL, except that when decoding parity-check (PC) bits, the parity check value of associated preceding bits is used as a bit decision result. In code construction, PC bits are generated in addition to frozen bits and information bits.

Polar codes are linear block codes. For a polar code of length N, its generator matrix is G_{N} and its encoding process is

$${x}_{1}^{N} = {u}_{1}^{N} {G}_{N} , where {u}_{1}^{N} = [ {u}_{1} , {u}_{2} , … , {u}_{N} ]$$

and is a binary input vector, and

$${x}_{1}^{N} = [ {x}_{1} , {x}_{2} , … , {x}_{N} ]$$

and is a binary code vector. The N×N binary generator matrix is

$${G}_{N} = {F}_{2}^{⊗ n} , where {F}_{2} = [ \begin{matrix}1 & 0 \\ 1 & 1\end{matrix} ]$$

and is the polarization kernel matrix (also known as the Arikan kernel or Arikan matrix), ⊗ represents a Kronecker product operation, and n=log₂ N.

With K information bits to be encoded into N code bits and K<N, a code rate of R=K/N<1 is obtained. This implies only part of

$${{u}_{1}^{N}}_{}$$

is used to carry information bits, and the remining bits of

$${{u}_{1}^{N}}_{}$$

are typically set to a fixed value and are known as frozen bits. The information bit set (or information set) may be denoted by I, and the frozen bit set (or frozen set) may be denoted by F. Sometimes, there is an additional PC bit set, denoted by P. The frozen bits are known and usually set to all zeros before decoding, so they do not carry any information. The PC bits are parity-check bits of a subset of information bits, and therefore are known once the associated information bits are decoded. Decoding of polar codes attempts to recover all information bits.

Code length M may, but might not always, be a power of 2, in which case M<N. In practice, puncturing and shortening are used to reduce the number of transmitted code bits from N to M. For convenience, N is referred to as mother code length, and M is referred to as code length herein. In particular, punctured bits of the mother code are untransmitted bits that are unknown to a decoder, but shortened bits are untransmitted bits that are known to the decoder (usually all zeros).

FIG. 5 is a trellis graph illustrating an example of a polar code with N=8 and K=4. Each “butterfly” in the graph is a polarization, and one butterfly is shown by way of example at the right in FIG. 5, for

$${x}_{1}^{2} = {u}_{1}^{2} [ \begin{matrix}1 & 0 \\ 1 & 1\end{matrix} ] .$$

In the example shown, the unshaded circles at the left represent the information set I={u₄, u₆, u₇, u₈}, and the shaded circles represent the frozen set F={u₁, u₂, u₃, u₅}.

The input vector u at the left in FIG. 5 and the code vector x at the right in FIG. 5 each include a number of bit positions. The bit positions in the input vector are indexed by respective bit indices, and bit values are placed on or at those bit indices or bit positions for encoding. These bit indices or bit positions are also sometimes referred to as bit channels or subchannels. Placing bit values on bit indices as disclosed herein may also be referred to in other ways, such as placing bits or bit values on or at bit indices, bit positions, bit channels, or subchannels; or assigning bit values or bits to bit indices, bit positions, bit channels, or subchannels. Other terminology may be used to express how bit values or bits are provided as inputs to encoding.

In this way, a polar code may be considered as providing or comprising bit indices, bit positions, bit channels, or subchannels for bit values. Those bit indices, bit positions, bit channels, or subchannels are not necessarily only for bits that are to be encoded. For example, the u vector elements u₁, . . . u_{N} are also referenced in decoding, and therefore bit values that are decoded may similarly be associated with bit indices, bit positions, bit channels, or subchannels.

On the right side in FIG. 5, the code vector x also includes a number of elements that are in or at bit positions or bit indices. A bit value on the i-th bit index in the input vector u has some effect on multiple code bits in the code vector x, but the bit value on the i-th bit index in the input vector u is the primary contributor to the value of the code bit on the corresponding i-th bit index in the code vector x. In this sense, for a polar code, input vector bit indices or bit positions may be considered to correspond to, or be associated with or related to, code vector bit indices or bit positions. This is the case for polar codes, and there may be different input/code bit correspondence, relationships, or associations for other types of codes.

Regarding encoding, the process of encoding may be expressed in any of various ways. For example, encoding may be described as encoding bits to obtain encoded bits or to generate encoded bits. The above-referenced encoding process

$${x}_{1}^{N} = {u}_{1}^{N} {G}_{N} ,$$

for example, may be expressed as generating or otherwise obtaining an encoding input (the input vector u in this example) that includes bits or bit values for encoding, to obtain or generate a number of encoded bits (the code vector x in this example).

The bit values of elements in the input vector u, from an encoding perspective, may be referred to as values or bits to be encoded, or as values or bits for encoding, for example. Blocks of bits or bit values for encoding are also sometimes referred to as code blocks. The bit values of elements in the code vector x may be referred to as encoded bits, coded bits, or code bits, and a block of such bits may be referred to as a codeword, for example.

From a decoding perspective, decoding may be referred to as decoding encoded bits, a codeword, or a code, or as decoding, obtaining, or recovering bits or bit values (that were encoded), from the encoded bits, a codeword, or a code, for example. The bit values of elements in the vector u, in the context of decoding, may be referred to as decoded or recovered bits or bit values.

In 5G NR, PC polar codes were adopted to increase the minimum code distance of conventional polar codes. In PC polar codes, values of parity check bits (also simply known as parity bits) are determined by their preceding information bits (i.e., information bits preceding the parity bit in the natural encoding and decoding order of the polar code). Specifically, the determination of a parity check bit may be a binary linear combination of a subset of preceding information bits. The binary linear combination is specified by a PC function, which may be expressed as:

$${u}_{i} + {u}_{j} + … + {u}_{k} = 0 ,$$

where i<j< . . . <k are bit indices. In this example, k is the largest index in the PC function, and uₖ is called a PC bit, the value of which is the binary sum of all other bits, which are preceding bits with lower bit indices, in the PC function.

PC bit positions for a PC set are selected from the indices among a non-frozen bit set (which is the information set I referenced above) with minimum row weights in the polar transformation matrix G_{N}. The non-frozen bit set is the complement set of the frozen set.

The 5G NR polar codes use a simple and hardware-friendly PC function over fixed spacing. With the fixed spacing set to 5, for a PC bit uₖ with index k, its value is based on all preceding information bits with spacing 5, and is set uₖ=uₖ₋₅+uₖ₋₁₀+uₖ₋₁₅+ . . . . The PC bits can be easily generated by a cyclic shift register of the same length as the fixed spacing. See H. Zhang et al., “Parity-Check Polar Coding for 5G and Beyond,” 2018 IEEE International Conference on Communications (ICC), 2018, pp. 1-7, doi: 10.1109/ICC.2018.8422462.

PC polar codes have also been proposed to support IR-HARQ. In one implementation, the PC bits are used for coupling multiple retransmissions into a longer polar code with extra coding gain. See M.-M. Zhao, G. Zhang, C. Xu, H. Zhang, R. Li and J. Wang, “An Adaptive IR-HARQ Scheme for Polar Codes by Polarizing Matrix Extension,” in IEEE Communications Letters, vol. 22, no. 7, pp. 1306-1309, July 2018, doi: 10.1109/LCOMM.2018.2825370.

In PC functions used for IR-HARQ, some information bits are copied from the initial transmitted code block to a retransmitted code block. This one-to-one parity checking between the two shorter code blocks effectively couples the two code blocks into a longer code block.

For example, consider an initial transmission of an (M₁=8, K=5) polar code, where {u₀, u₁, u₂, u₃, u₄} is the information set, {u₅, u₆, u₇} is the frozen set, bit indices are in decreasing order of reliability, and the transmitted code bits are c₀, c₁, c₂, c₃, c₄, c₅, c₆, c₇. In a first retransmission, four additional code bits c₈, c₉, c₁₀, c₁₁ are transmitted. These four code bits are coupled with the initially transmitted 8 bits to form an (M₂=12, K=5) polar code. The coupling is achieved by copying the value of u₄ to u₈ during encoding, thus generating a PC function u₄+u₈=0 (or equivalently u₈=u₄). The smallest index in this PC function corresponds to the PC bit (here u₄). During decoding, u₈ is decoded as an information bit, while u₄ is decoded as a PC bit using the PC function u₄+u₈=0 (or equivalently u₈=u₄). In this example, {u₀, u₁, u₂, u₃, u₈} is the information set, {u₄} is the PC set, and {u₅, u₆, u₇, u₉, u₁₀, u₁₁} is the frozen set. In a second retransmission, four more additional code bits c₁₂, c₁₃, c₁₄, c₁₅ are transmitted to form an (M₃=16, K=5) polar code, but no new PC bits are generated in this second retransmission.

Existing PC polar codes have been used to either improve minimum code distance, or couple short code blocks into a longer one. However, they have several drawbacks.

Consider, for example, current 5G NR polar codes that use a PC function over fixed spacing. Although the PC function generation method may be simple, the method is also restricted in its design space, such as in terms of a PC function only defining the placement of one parity check bit value on one bit index. Bit value placement on two or more bit indices, for example, would involve numerous PC functions, which may be overly complex for both description and implementation.

Also, a PC function as described by way of example above as copying the value of u₄ to u₈ during encoding can couple only two blocks. This type of PC function generation method is limited in that it does not support coupling more than two blocks.

The specific PC function generation (information bit copying) method previously proposed for IR-HARQ couples the least reliable information bit(s) from the initial transmission, which is u₄ in the above example, with the most reliable bit position(s) in the retransmission, which is u₈ in the above example first retransmission. This rule may lead to catastrophic performance loss when coupled code blocks have very different lengths for example.

In the above examples, the PC function descriptions are also not efficient, in terms of describing, defining, or specifying how such functions are to be performed in a communication standard or specification for example, when more general coupling among multiple code blocks is to be supported.

Another potential issue with the examples provided above is that there are many frozen bits in current PC polar codes. These frozen bits are typically set to zero (or another known value), and do not carry any information, which impacts code performance.

Some embodiments disclosed herein are directed to addressing a technical problem related to providing a more general method to couple shorter polar codes or codewords together. When more than two code blocks are to be coupled, description (in communication standards or specifications for example) and implementation (in hardware for example) of PC functions for current PC bit-based approaches are not efficient.

Disclosed embodiments may also or instead be relevant to a technical problem of enabling self-decodability for polar codes. When only a subset of code bits of a self-decodable polar code is received, which may be possible under deep fading for example, all information bits may still be recoverable.

In some embodiments, bits that provide or enable check-type features can carry additional information. This is different from conventional techniques in which PC bits do not carry information.

Bit value placement as disclosed herein relates to placing bit values on bit indices for encoding. In some embodiments, this may involve assigning labels to bit values (or equivalently assigning bit values to labels) and assigning the labels and thus the bit values to bit indices (or equivalently assigning the bit indices to the labels and thus the bit values) for encoding. These features may equivalently, and more generally, be referred to as placing bit values on bit indices.

Although the present disclosure refers to labels in the context of many embodiments, not all embodiments necessarily involve labels. Labels are proposed as a convenient way to manage placement of bit values on bit indices, but bit value placement is not in any way restricted to using labels. Bit values may be placed on bit indices without first assigning the bit values to labels (or assigning the labels to the bit values). Features that are disclosed herein with reference to labels may also or instead be applied to bit values.

Turning now to an example that uses labels, with K denoting the number of input bits to be encoded, a label from {1, 2 . . . K} (or equivalently {0, 1 . . . K−1}) may be assigned to, and thereby associated with, each input bit. In an input vector

$${u}_{1}^{N} = [ {u}_{1} , {u}_{2} , … , {u}_{N} ]$$

for encoding, bit indices that are to have the same binary value are assigned the same label and thus are associated with the same label, or in other words the same label is assigned to those bit positions in the input vector.

More generally, bit indices that are to have the same binary value are assigned the same bit value and thus are associated with the same bit value, or in other words the same bit value is assigned to those bit indices in the input vector. Bit values are placed, possibly using labels, on bit indices for encoding. The same bit value is placed on and may be considered to be assigned to and/or associated with multiple bit indices. Such bit value placement can be used to create a form of check-type function for any bit indices sharing the same bit value, and the same label in some embodiments. Where multiple bit indices are associated with the same bit value or label, a check-type function is created. In the case of the same bit value being placed on two bit indices, which are associated with the same label for example, this check-type function is pairwise, and relates two bit indices and the bit value on those bit indices to each other. With multiple bit indices having the same bit value placed thereon, and associated with the same label in some embodiments, the corresponding check-type function or relationship between bit indices (and accordingly the bit value on those bit indices) may be considered as having a dimension or order higher than two (where two would be pairwise). Alternatively, the corresponding check-type function or relationship may be considered as multiple pairwise functions or relationships between any pair of the multiple bit indices on which the same bit value is placed, or to which the same label (and the bit value on those commonly-labeled bit indices) is assigned.

In some embodiments, a longer code block to be encoded is divided or partitioned into several shorter code blocks (also referred to herein as sub code blocks or subblocks), and a set of bit values or labels (or a subset of the set) is placed on or assigned to each code block and the subchannels or encoding bit positions related to each code block. Code blocks in which overlapping bit value sets are placed or label sets including one or more of the same labels are assigned are, in effect, coupled with each other through the common bit value(s) or label(s). A common bit value or label associated with multiple code blocks not only creates a check-type function or relationship between individual bit indices and bits, but also couples information bits, code blocks, and code bits after encoding, to each other.

There are several fundamental differences between the embodiments disclosed herein and the existing approaches described above.

For example, instead of allocating code rates (or equivalently a number of information bits), according to an aspect of the present disclosure bit value or label sets (or subsets) are placed on or assigned to bit indices. The code rate for codewords is not fixed. Among bit indices with the same bit value or label, a bit that is decoded first can be regarded as an information bit and be counted in the code rate, and all other bits on indices that share the same bit value or label are determined based on the bit value or label and are not counted in the code rate. Therefore, with bit value placement as disclosed herein, code rate may be undetermined during code construction and encoding, and accordingly bit value placement is not equivalent to allocating code rates.

Considering the size of the bit value or label sets (or subsets) assigned to each code block, determining these sizes is also different from rate allocation. According to embodiments herein, a bit value or label can be assigned to bit indices in multiple code blocks, whereas in rate allocation an information bit can only be assigned to one code block. For example, in conventional techniques a long code block for encoding may have K bits, among which K bits are allocated to an upper subblock, and K₊ bits are allocated to a lower subblock, and the following is strictly guaranteed: K=K₋+K₊. With subblocks and bit value placement as disclosed herein, a long code block may have a bit value or label set L, among which a subset L₋ is assigned to an upper subblock, and a subset L₊ is assigned to a lower subblock, for example. Some bit values or labels can appear in both L₋ and L₊. With |L| denoting the size of the label set L, the following may apply in some embodiments: |L|≤|L₋|+|L₊|.

Bit values or labels may be assigned based on any of various parameters or criteria. For example, embodiments may involve assigning bit values or labels according to any of various rules, based on one or more of reliability, bit index, etc. Reliability may be considered a measure or indication of how likely it is that a bit value will be correctly decoded or decodable at a decoder. Other related terms or descriptors include capacity, probability or likelihood of error, and probability or likelihood of decoding without error. Reliability is primarily used herein, but features disclosed herein in the context of reliability may also or instead apply in the context of capacity, probability or likelihood of error, probability or likelihood of decoding without error, or other measures or indicators of rank or preference between bit indices for the purpose of placing input bit values for encoding.

These and other aspects and embodiments are described in further detail herein, at least below.

Bit indices or positions (subchannels) for bit values before encoding may be assigned and thereby associated with labels, which is one possible way to place bit values on bit indices. These bit indices include at least information bit indices for values of input bits that are to be encoded (also referred to herein as information bits), and may also include frozen bit indices for frozen bits that are set to a predetermined known bit value. For information bits and frozen bits, the frozen bit positions may be labeled as “0” or another value that is not used for information bits, and the information bit positions (Kin number) may labeled as l∈{1, 2 . . . K}. More generally, information bit indices are for placing input bit values, and frozen bit indices are for placing a predetermined value. Code construction and encoding may be performed according to the bit value placement.

For multiple bit indices to which the same label is assigned or on which the same bit value is placed, once the bit value at any one of these bit indices is decoded, the remaining bits at indices with the same bit value or label are immediately known, because of the relationship or check-type function that is created by the common, shared bit value or label. Decoding of an input bit for a first bit index among bit indices that have the same bit value or label may be according to a polar code, whereas decoding for other bit indices associated with the same bit value or label may reduce to setting the bit values to the same value as the first decoded input bit, based on the label or the same bit value having been placed on those other bit indices. In this sense, the first decoded bit is processed as an information bit in terms of encoding and decoding. The other information bits at bit indices associated with the same bit value or label need not undergo the same decoding that would normally be applied to information bits, and in this sense may be considered a form of check bit.

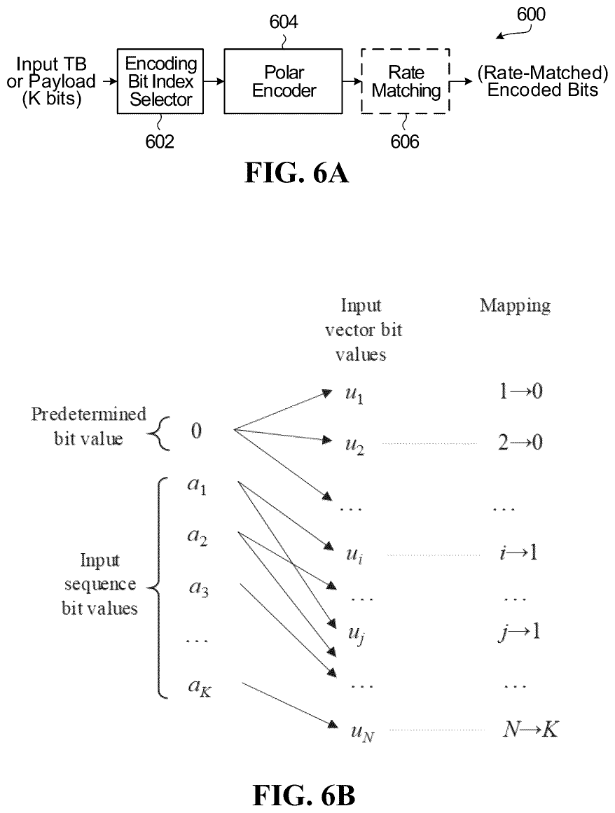

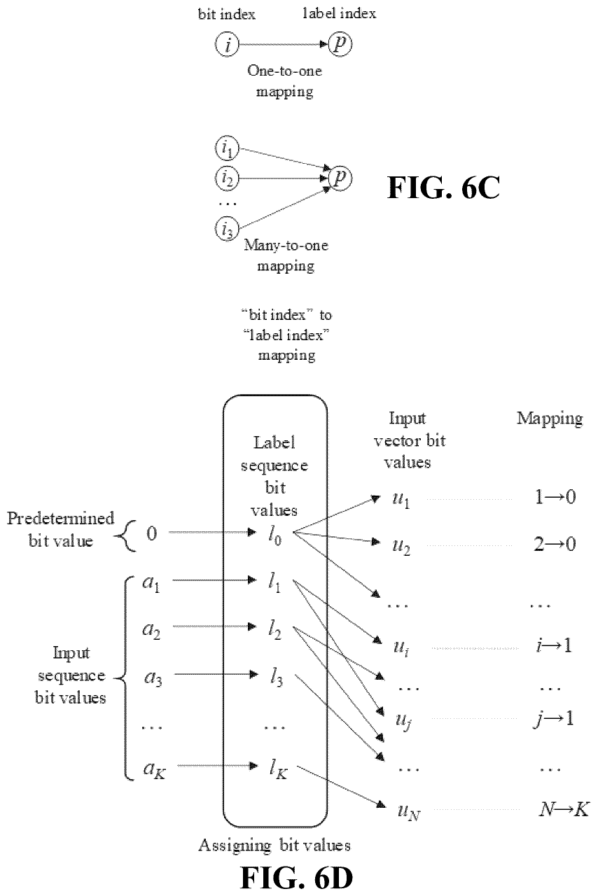

FIG. 6A is a block diagram illustrating an apparatus in which embodiments disclosed herein may be implemented or supported. The example apparatus 600 includes an encoding bit index selector 602, a polar encoder 604 coupled to the encoding bit index selector, and an optional rate matching module 606 coupled to the polar encoder. Input bits for encoding are shown as input transport block (TB) or payload bits, and (optionally rate-matched) encoded bits are shown as an output of the apparatus 600. An interface for transmitting or otherwise outputting the encoded bits may be provided by, incorporated into, or coupled to, the polar encoder 604 and the rate matching module 606 in the example shown.

Encode-side or transmit-side features or functions, and other features or functions herein, may be implemented in any of various ways, such as in hardware, firmware, or one or more components that execute software. The present disclosure is not limited to any specific type of implementation, and implementation details may vary between different devices, for example.

In the example apparatus 600, the encoding bit index selector 602 is intended to represent a logic unit that is configured, by executing software for example, to place bit values on bit indices, for encoding by the polar encoder 604. The polar encoder 604 is configured, by executing software for example, to encode input bits to obtain encoded bits. The rate matching module 606 is configured, by executing software for example, to perform rate matching, and may include a circular buffer for storing encoded bits from the polar encoder 604.

The apparatus 600 is intended purely as an illustrative example. Embodiments are not in any way limited to implementation in the manner shown. Apparatus embodiments may include fewer, additional, and/or different components.

More generally, an apparatus that provides or supports features disclosed herein may be implemented in any of various ways. An apparatus or a component thereof such as an encoding bit index selector 602, a polar encoder 604, a rate matching module 606, or a processor may be configured to, or programming may include instructions to or to cause a processor to, encode input bits and output encoded bits. Other features disclosed herein, including decode-side or receive-side features, may similarly be implemented in apparatus embodiments. For example, an apparatus may include an interface to receive encoded bits and a decoder to decode the encoded bits to obtain decoded input bits, and these and/or other components may be configured to provide or support other features. An apparatus need not include these specific components, and accordingly in general an apparatus or a component thereof such as a processor may be configured to, or programming may include instructions to or to cause a processor to perform or otherwise provide or support decode-side or receive-side features disclosed herein.

FIG. 6B is a block diagram illustrating bit value placement on bit indices according to an embodiment. Bit value placement may involve or be based on a bit index (or bit position) to bit value mapping, which may also be referred to as a bit value to bit index or bit position mapping, or as a mapping between a bit index or bit position and a bit value. Such a mapping may be either a one-to-one mapping or a many-to-one mapping.

A one-to-one mapping may be defined by or expressed as i→p, where i is a bit index of a bit position, in the input vector shown in FIG. 6B for example, and p is an index of a bit value, in a sequence of bit values such as the input sequence shown in FIG. 6B. For example, an input vector bit uᵢ with a one-to-one mapping to a bit value may be a frozen bit if there is only one frozen bit, or an information bit for an input bit value that is not to be placed on any other bit indices. In this sense the one-to-one mapped information bit is an information bit that is not checked by any other information bit in the input vector. This type of mapping may be referred to as a direct mapping between a bit value and a bit index, in that the mapping does not use a label. The mapping N→K in FIG. 6B is an example of a direct one-to-one mapping.

A many-to-one mapping may be defined by or expressed as {i₁, i₂, i₃ . . . }→p, where i₁, i₂, i₃ . . . are bit indices of bit positions, and p is an index of the bit value to which these bit indices are mapped. For example, the mapping {i,j,k}→p is consistent with a check-type function or relationship uᵢ=uⱼ=uₖ. Among {i,j,k}, if the bit uⱼ is decoded first, then the other bits uᵢ and uₖ take the same decoded value of uⱼ, and in this sense uᵢ and uₖ are information bits but may be considered a form of check bit. A many-to-one bit index to bit value mapping (or one-to-many bit value to bit index mapping) is a direct mapping, between a bit value and multiple bit indices or vice versa. The mappings for input bit values a₁ and a₂ in FIG. 6B are examples of a direct one-to-many or many-to-one mapping.

In FIG. 6B, input sequence bit values include the input bit values (aᵢ). The input bit sequence represents an input block to channel coding, and bit values in that bit sequence are denoted by a₁, a₂, . . . , a_{K}, where K is the number of bits to be encoded. The bit values in the input bit sequence, and a predetermined bit value for frozen bits (0 in the example shown) are placed on bit indices in the binary input vector u₁, u₂, . . . , u_{N}, upon which polar coding is applied, based on the bit index/value index mapping shown at the right in FIG. 6B. The arrows between the input sequence bit values and the input vector bit values are intended to represent bit value placement according to which the input vector bit values are set to the input sequence bit values. Placement of a predetermine bit value of 0 for frozen bits is also shown in FIG. 6B for completeness.

The example shown in FIG. 6B illustrates the predetermined frozen bit value 0 and the input bit values a₁, a₂, . . . , a_{K} being placed on bit indices in the binary input vector u₁, u₂, . . . , u_{N}. Using notation introduced above, uᵢ=aₚ if i→p for a one-to-one mapping or { . . . i . . . }→p for a many-to-one mapping.

Bit value placement of a predetermined value of 0 for all frozen bits and input bit values for a sequence of input bits {1, 2 . . . K}, can be described by a mapping sequence. With i∈{1, 2 . . . N} denoting bit indices of bit positions for encoding, and l∈{0, 1 . . . K} denoting bit value indices for the predetermined value of 0 for frozen bits and input bit values a₁, a₂, . . . , a_{K}, a one-to-one mapping i→p can be denoted by l(uᵢ)=p, a many-to-one mapping {i,j,k}→p can be denoted by l(uᵢ)=l(uⱼ)=l(uₖ)=p, and the mapping sequence can be denoted by l(u₁), l(u₂), . . . , l(u_{N}), where Nis mother code length or a total number of bit indices. For the example shown in FIG. 6B, a mapping sequence may be described as {0, 0, 0, . . . , 1, 2, . . . , 1, 2, 3, . . . , K}.

Bit value placement may involve labels in some embodiments. A bit index (or bit position) to label mapping (which may also be referred to as a label to bit index or bit position mapping, or as a mapping between a bit index or bit position and a label) may, like a bit index/bit value mapping, be either a one-to-one mapping or a many-to-one mapping.

A one-to-one mapping using labels may be defined by or expressed as i→p, where i is a bit index of a bit position as above, but p is an index of a label. For example, an input vector bit uᵢ with a one-to-one mapping to a label may be a frozen bit if there is only one frozen bit, or an information bit that does not share a label with, and in a sense is not checked by, any other information bit.

A many-to-one mapping using labels may be defined by or expressed as {i₁, i₂, i₃ . . . }→p, where i₁, i₂, i₃ . . . are bit indices of bit positions as above, and p is an index of the label to which these bit indices are mapped. For example, the mapping {i,j,k}→p is consistent with a check-type function or relationship uᵢ=uⱼ=uₖ. Among {i,j,k}, if the bit uⱼ is decoded first, then the other bits uᵢ and uₖ take the same decoded value of uⱼ, and in this sense uᵢ and uₖ are information bits but may be considered a form of check bit.

FIG. 6C is a block diagram illustrating example bit index to label mappings. In FIG. 6C, bit index to label mapping is represented with bit indices to the left and label indices to the right. The top mapping is a one-to-one mapping and the bottom mapping is a many-to-one mapping. Label mapping is optional, and bit indices may instead be directly mapped to bit values or indices, rather than via labels, as described above and elsewhere herein. Use of label mapping, rather than direct mapping, may be preferable in some embodiments. For example, when described in text in a communication standard or specification, bit values of input bits are not known, and labels may be used to represent the input bit values. As a result, bit mapping and bit value assignment may be more conveniently described through the use of labels as a form of reference for the bit values. A label-based description may also be logically clearer in describing different functionalities, such as read-out and assign-to rules or conditions, which are described below.

FIG. 6D is a block diagram illustrating bit value placement on bit indices, using bit labeling according to an embodiment. In FIG. 6D, input sequence bit values include the input data bit values (aᵢ), and a predetermined bit value of 0 is also illustrated for completeness. Bit values of a label sequence, with individual elements in such a sequence being labels that are assigned to bit positions or bits in an input vector for encoding, are also shown in FIG. 6D. The arrows between the bit values and the label sequence bit values represent both assignment of the labels and setting or assignment of bit values to the labels. The labels include labels that are respectively uniquely assigned to and thereby associated with bit positions in the input sequence, and a frozen bit label as well in the example shown. For encoding a sequence of input bits, the labels are set to the bit values of the input bits. This may equivalently be referred to as the labels being assigned to input bits or input sequence bits (or values), or as the input bits or input sequence bits (or values) being assigned to the labels. The relationship between each one of the K input bits and its assigned label is a unique, in that each input bit has only one uniquely assigned label, and no individual label is assigned to any other input bit. This may be considered another form of one-to-one mapping, between input bit positions (or bits) in an input bit sequence and respective labels.

The input bit sequence in FIG. 6D represents an input block to channel coding, and bit values in that bit sequence are denoted by a₁, a₂, . . . , a_{K}, where K is the number of bits to be encoded. The label sequence is denoted by l₀, l₁, l₂, . . . , l_{K}, where each label l₁, l₂, . . . , l_{K} is associated with an input bit position and input bit that is to be encoded, or with a predefined frozen bit value in the case of label l₀. The predetermined bit value and the bit values in the input bit sequence are assigned to bit indices in the binary input vector u₁, u₂, . . . , u_{N}, upon which polar coding is applied, based on the labels and the bit index/label mapping shown at the right in FIG. 6D. The arrows between the label sequence bit values and the input vector bit values are intended to represent both assignment of the labels to input vector bit positions, and bit value assignment according to which the input vector bit values are set to the predetermined bit value or the input sequence bit values.

In the bit placement examples shown in FIGS. 6B and 6D, (without and with labels, respectively) the predetermined frozen bit value 0 and the input bit values a₁, a₂, . . . , a_{K} are placed on bit indices. With labels, the bit values are assigned as values of the label sequence l₀, l₁, l₂, . . . , l_{K}, where l₀=0 (or any predefined frozen bit value), and lₚ=aₚ for p=1, 2 . . . K. Then, the bit values 0, a₁, a₂, . . . , a_{K}, optionally having been assigned as bit values to the labels, are placed on bit indices in the binary input vector u₁, u₂, . . . , u_{N}. Using notation introduced above, uᵢ=aₚ (or lₚ in a labeling embodiment) if i→p for one-to-one mapping or { . . . i . . . }→→p for many-to-one mapping.

A mapping sequence that describes bit value placement may include bit value indices as in preceding examples, or labels in label embodiments. A one-to-one mapping i→p can be denoted by l(uᵢ)=p, a many-to-one mapping {i,j,k}→p can be denoted by l(uᵢ)=l(uⱼ)=l(uₖ)=p, and the mapping sequence can be denoted by l(u₁), l(u₂), . . . , l(u_{N}), where Nis mother code length or a total number of bit indices. For the example shown in FIG. 6D, a mapping sequence may be described as {l₀, l₀, l₀, . . . , l₁, l₂, . . . , l₁, l₂, l₃, . . . , l_{K}}.

A mapping sequence, whether expressed or defined using bit value indices or labels, could be defined in a communication standard or specification, or generated according to a procedure specified by such a standard or specification, for example. Online generation of such a mapping sequence is one possible option.

In some embodiments, bit value placement as disclosed herein, including but not limited to bit labeling, may be used in conjunction with coupled or nested codes.

One option for code coupling is to divide a code block into multiple shorter and non-overlapping code blocks (also referred to herein as sub code blocks or subblocks) and assign a set of bit values or labels (or a subset of the set) to the bit indices in each code block. If bits in multiple code blocks have the same bit value or label, then that bit value or label couples the code blocks to each other and, as a result, also couples their corresponding coded blocks (also referred to herein as codewords) to each other. There may be more than one common bit value or label coupling code blocks and coded blocks to each other in this manner. Multiple coded blocks can be further coupled to each other by performing XOR operations on bits of those coded blocks.

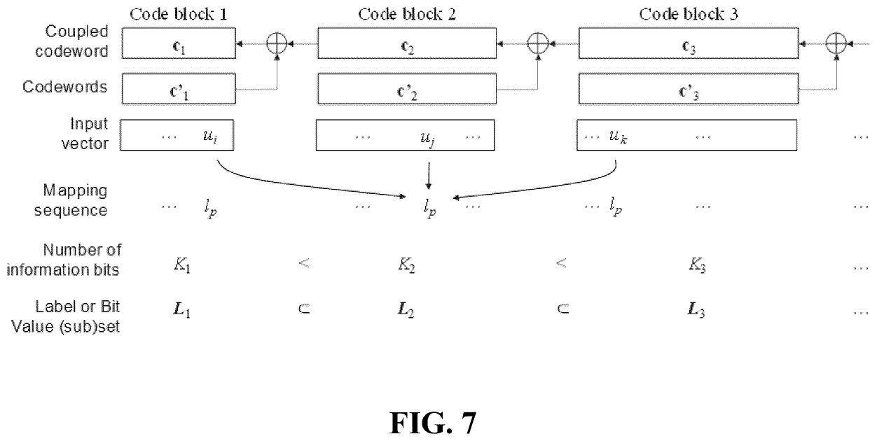

FIG. 7 is a block diagram illustrating code coupling according to an embodiment. The example shown in FIG. 7 encompasses both mapping sequence-based code coupling and XOR-based code coupling.

With B denoting a number of code blocks (three, represented by the input vectors FIG. 7) and Kᵢ denoting the number of information bits in the i-th code block, without loss of generality consider an illustrative example in which K₁<K₂< . . . <K_{B}, where B=3 in FIG. 7. At least Kᵢ most reliable bit positions are allocated for encoding the information bits in the i-th code block. More than Kᵢ most reliable bit positions are allocated in embodiments that are to support a many-to-one mapping of multiple bit positions to a single bit value or label within a single code block.

For ease of reference, the bit value or label set or subset of the i-th code block is denoted by Lᵢ. The bit value or label set of a code block is a subset of the bit value or label set of another code block. Specifically, either of the following should be satisfied (where B=3 in FIG. 7):

L⊂L₂⊂L₃⊂ . . . ⊂L_{B} (as in the example in FIG. 7)

$${L}_{1} ⊂ {L}_{B} , and {L}_{2} ⊂ {L}_{B} , and {L}_{3} ⊂ {L}_{B} , and … , and {L}_{B 1} ⊂ {L}_{B} .$$

The code blocks are non-overlapping, and for the purpose of this example it is presumed that each code block has a length that is a power of 2. Other code block lengths are possible, and a power of 2 length is only an example.

A coupled codeword that is already coupled to one or more other codewords by a common bit value or label in their corresponding input vectors may be further coupled to each other by performing XOR operations as shown by way of example in FIG. 7, or potentially combining codewords or portions of codewords in some other way. In FIG. 7, cᵢ is a coupled codeword obtained as follows: cᵢ=cᵢ′⊕c′ⱼ. Codeword that are combined to obtain a coupled codeword may have the same or different lengths. With reference again to FIG. 7, if c′ᵢ and c′ⱼ have different lengths Nᵢ and Nⱼ, and Nᵢ<Nⱼ, then only a subset of the bits the longer codeword, such as the last (or first, or another subset of) Nᵢ code bits in c′ⱼ are combined via an XOR operation with the code bits of c′ᵢ. An XOR operation is an example of combining, and other types of combining may be used in other embodiments to combine codewords to obtain a coupled codeword.

Two example ways of coupling codewords by combining, and in particular by XOR operations in these illustrative examples, are provided below.

### Example 1

$${c}_{1} = {c}_{1}^{′} ⊕ {c}_{2}^{′} ⊕ {c}_{3}^{′} ⊕ … ⊕ {c}_{B}^{′}$$

$${c}_{2} = {c}_{2}^{′} ⊕ {c}_{3}^{′} ⊕ … ⊕ {c}_{B}^{′}$$

$$…$$

$${c}_{i} = {c}_{i}^{′} ⊕ {c}_{i + 1}^{′} ⊕ … ⊕ {c}_{B}^{′}$$

$$…$$

$${c}_{B - 1} = {c}_{B - 1}^{′} ⊕ {c}_{B}^{′}$$

$${c}_{B} = {c}_{B}^{′}$$

### Example 2

$${c}_{1} = {c}_{1}^{′} ⊕ {c}_{2}^{′}$$

$${c}_{2} = {c}_{2}^{′} ⊕ {c}_{3}^{′}$$

$$…$$

$${c}_{i} = {c}_{i}^{′} ⊕ {c}_{i + 1}^{′}$$

$$…$$

$${c}_{B - 1} = {c}_{B - 1}^{′} ⊕ {c}_{B}^{′}$$

$${c}_{B} = {c}_{B}^{′}$$

These are illustrative and non-limiting examples, and embodiments are not in any way restricted to these or any other types of codeword combining.

As shown in FIG. 7 by way of example, even though the code blocks (which are the input vectors in the drawing) are non-overlapping, the bit value or label sets of the code blocks overlap, as shown by (L₁⊂L₂⊂L₃). There is also a many-to-one mapping between a bit position in each code block and a common, shared bit value or label (lₚ) that in effect couples the code blocks to each other. The code blocks and codewords in FIG. 7 are coupled in two ways, by bit value placement (which may use labeling for example) and by codeword combining. Bit value placement, but bit labeling or without labels, may be used in conjunction with codeword combining as shown, or independently from codeword combining.

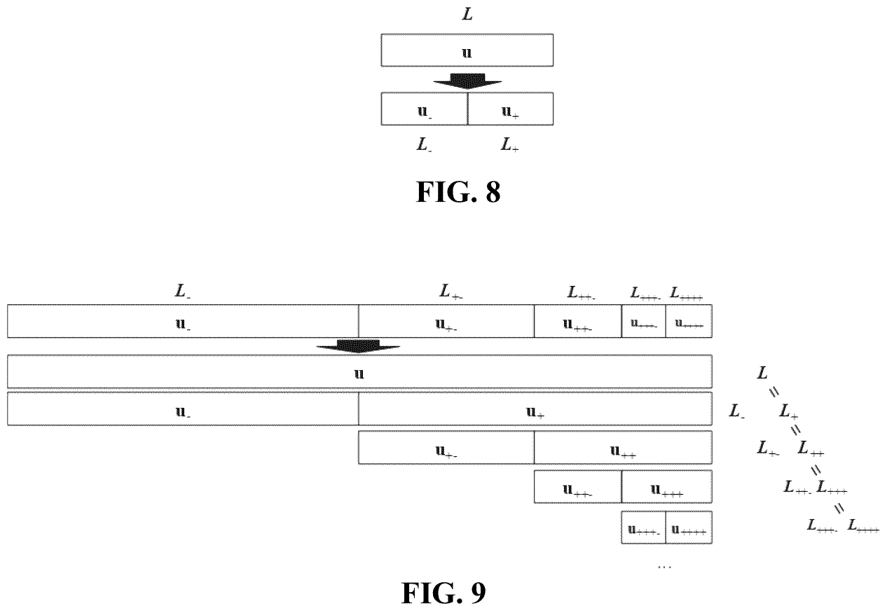

According to another possible option for code coupling, a code block contains multiple nested code blocks that overlap, and a set of bit values or labels (or a subset of that set) is placed on or assigned to the bit indices in each code block. FIG. 8 is a block diagram illustrating code coupling according to such an embodiment. In the example shown, a larger code block shown as u in FIG. 8 to be consistent with notation in FIGS. 6 and 7, for example, contains shorter code blocks u₊ and u₋. The code blocks u and u₊ have the same bit value or label set (L=L₊). However, a subset L₋ of the bit value or label set L₊ of code block u₊ is the bit value or label set for u₋, which may be referred to as a complement block of u₊ in the larger code block u. This is explained in further detail below.

In FIG. 8, u denotes the larger code block, u₊ denotes a shorter code block with the same bit value or label set, and u₋ is a complement block of u₊, satisfying u=[u₋⊕u₊, u₊]. The respective numbers of information bits for encoding in u, u₊, and u₋ are K, K₊ and K₋, and K₋<K₊<K. Their respective bit value or label sets are denoted by L, L₊ and L₋.

At least the most reliable K, K₊ and K₋ bit positions are allocated for encoding the information bits in u, u₊, and u₋. For ease of reference, the respective information sets for u, u₊, and u₋ are denoted by I, I₊, and I₋.

All of the K₋ information bit positions allocated for u₋ are a subset of the K information bit positions for u, but the K₊ information bit positions allocated for u₊ are not a subset of the K information bit positions in u.

L₊=L, L₋⊂L₊, and L₋=l(I₋)=l(I₊\I), where l(I) denotes the bit value or label set corresponding to an information set I, and I₊\I={i: i∈I₊ and i∉I} is the information set difference between I₊ and I. For simplicity, the bit value or label “0” for frozen bits is not included in this example, but a bit value or label set can always include a predetermined bit value or a label to which a zero or another frozen bit value is assigned.

The property or condition L₊=L supports self-decodability for the code block u₊, which means that the code block u₊ is self-decodable from encoded bits even when all signals in u₋ are not received, because u₊ contains all of the information bits in u, or equivalently L₊ includes all the labels in L.

Bit value placement or labeling may be done recursively in some embodiments, to construct longer codes, where u₊ can be further divided into u₊₋ and u₊₊, and/or where u₋ can be further divided into u₋₋ and u₋₊. More generally, u* can be further divided into u*₋ and u*₊, where * denotes any code block bit sequence consisting of + and − nested, shorter code blocks.

There are several ways to provide recursive bit value placement, by bit labeling or otherwise, and FIG. 9 is a block diagram illustrating code coupling with recursive bit value placement, according to an embodiment. The example shown in FIG. 9 may be considered a less aggressive option for recursive bit value placement or labeling, in the sense that only one shorter code block is divided or partitioned into shorter blocks.

According to this option, given a maximum mother code length N₀, and information length K, only one of the shorter code blocks at each level or stage is recursively divided into shorter code blocks, until the length of the shorter code blocks would become smaller than K, or equivalently as long as the length of the shorter code blocks is at least K, or is greater than or equal to K. For K input bits, a transmitted code length K is an absolute minimum code length to potentially support correct decoding of the input bits. In practice, it is expected that a shortest transmitted code length would be N′>K.

The shorter code block that is further divided at each level or stage is preferably the u*₊ code block that has the same bit value or label set as the longest code block u, to enable self-decodability of the u*₊ code blocks. Although it is possible to instead recursively divide the complement block u*₋ in a similar manner, recursively dividing only the complement block u*₋ does not provide self-decodability because the bit value or label set of the complement block u*₋ is only a subset of the bit value or label set of code block u*₊ (and the bit value or label set of code block u.

FIG. 9 illustrates the preferred option of recursively dividing u*₊ code blocks into shorter code blocks u*₊₋ and u*₊₊. At each level or stage of recursive code block division, the following label set properties or conditions are satisfied: L*₊=L* (as shown at the right in FIG. 9) and L*₋⊂L*₊. Also L*₋=l(I*₋)=l(I*₊\I*). Although this example refers primarily to recursively dividing a code block into multiple shorter code blocks, bit value placement, by bit labeling or otherwise, is also recursive.

The following is an example of pseudocode to provide a recursive function:

$$N = {N}_{0} ;$$

### While N>N′

Denote the current block by u*, and its bit indices by 1:N;
Allocate the most reliable K* bit indices for encoding information bits in u*.

Assign the bit value or label set L* to u*.
Denote the code block with bit indices 1:N/2 by u*₋, and the code block with indices N/2+1:N by u*₊;
Allocate the most reliable K*₊ and K*₋ bit indices for encoding information bits in u*₊, and u*₋, respectively;
Assign bit value or label sets L*₊ and L*₋ to u*₊, and u*₋, respectively, satisfying L*+=L*, and L*₋⊂L*₊, and L*₋=l(I*₋)=l(I*₊\I*).

$$u * = u {*}_{+} ;$$

$$N = N / 2 ;$$

End while

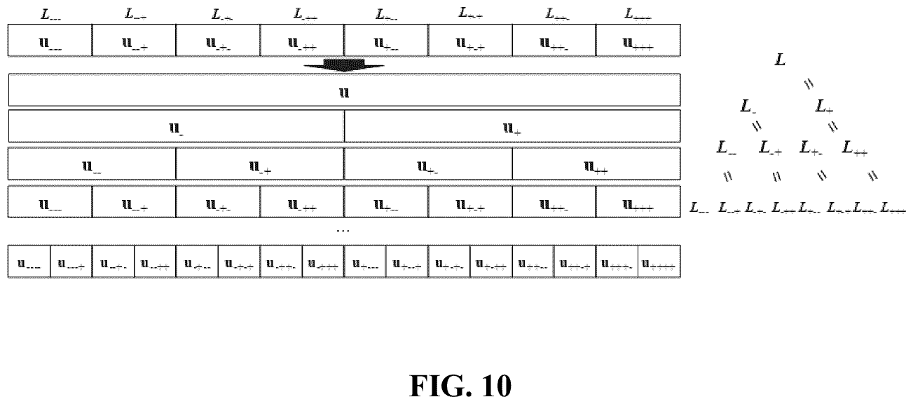

A more aggressive approach to recursive bit value placement, in terms of generating a higher number of shorter code blocks, involves recursively dividing multiple shorter code blocks at each level or stage. FIG. 10 is a block diagram illustrating code coupling with an example of this type of recursive bit value placement and code block dividing or partitioning.

According to this approach, given a maximum mother code length N₀, and information length K, multiple code blocks are recursively divided at each level or stage into multiple shorter code blocks, until the length of any shorter code block would be less than the information length of its immediate longer “parent” block, or in other words code blocks may be recursively divided as long as the length of each shorter code block is at least, meaning greater than or equal to, the information length of its immediate parent block. Information length is one possible parameter based upon which a determination may be made as to when to end a recursive process. A minimum transmitted code length N′>K is another example of such a parameter.

FIG. 10 illustrates an example in which both u*₊ and u*₋ code blocks are recursively divided into shorter code blocks, u*₋₋/u*₋₊ and u*₊₋/u*₊₊, respectively, at each level or stage. The following bit value or label set properties or conditions are satisfied at each level or stage: L*₊=L* (as shown at the right in FIG. 10), L*₋⊂L*₊, and L₋=l(I*₋)=l(I*₊\I*). As noted at least above for the less aggressive recursive division example, although this more aggressive example refers primarily to recursively dividing a code block into multiple shorter code blocks, bit value placement, by bit labeling or otherwise, is also recursive.

The following is an example of pseudocode to provide this type of recursive function:

$$N = {N}_{0} ;$$

Function assign_bit_values(u*, N, K)
Denote the current block by u*, and its bit indices by 1:N;
Allocate the most reliable K* bit indices for encoding information bits in u.

Assign the bit value or label set L* to u*.
Denote the code block with bit indices 1:N/2 by u*₋, and the code block with indices N/2+1:N by u*₊;
Allocate the most reliable K*₊ and K*₋ bit indices for encoding information bits in u*₊, and u*₋, respectively;
Assign bit value or label sets L*₊ and L*₋ to u*₊, and u*₋, respectively, satisfying L*₊=L*, and L*₋⊂L*₊, and L*₋=l(I*₋)=l(I*₊\I*).

$$K {*}_{-} = \vert L {*}_{-} \vert ;$$

$$K {*}_{+} = K ;$$

$$assign\_bit \_values ( u {*}_{-} , N / 2 , K {*}_{-} ) ;$$

$$assign\_bit \_values ( u {*}_{+} , N / 2 , K {*}_{+} ) ;$$

End function

These examples for recursive code block dividing or partitioning and recursive bit value placement are intended to be illustrative and non-limiting. Variations are possible.

For example, division of a code bock into two shorter code blocks at each stage may be preferred for a power of 2 mother code length, but a longer code block may be divided into more than two shorter code blocks in other embodiments. In general, in each recursion, a length N code may be divided into blocks of length N*ₐ, N*_{b}, N*_{c}, . . . , as long as N*=N*a+N*_{b}+N*_{c}+ . . . , and these blocks may include blocks that have equal length, unequal lengths, or some blocks with the same length and one or more other blocks with different lengths.

Embodiments are also not restricted to shorter code blocks that have the same length. For example, in each recursion, two shorter blocks may have different lengths, such as N*₋ and N*₊, instead of N*/2 and N*/2, as long as N*=N*₋+N*₊.

Various options for code coupling are described in detail at least above, and there are also several options for assigning bit values or labels, or bit value or label sets, to bit indices.

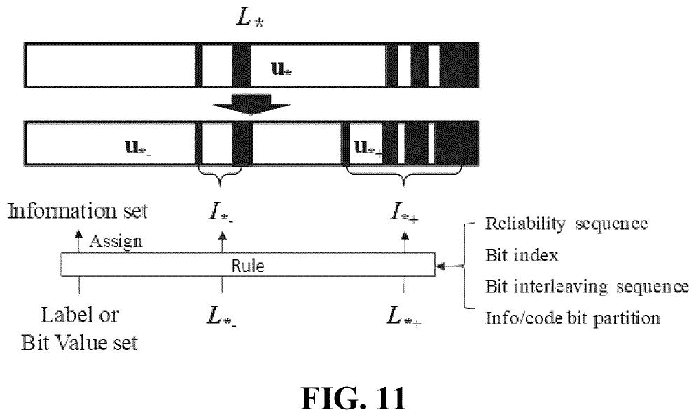

With reference to the foregoing examples of recursive bit value placement, consider the bit value or label sets L*₊ and L*₋ that are assigned to u*₊, and u*₋, respectively, satisfying L*₊=L*, and L*₋⊂L*₊, and L*₋=l(I*₋)=l(I*₊\I*). In short, there are bit value or label sets L*₋ and L*₊ and information sets I*₋ and I*₊ for encoding, and the individual bit value or labels in each bit value or label set are to be assigned to input vector bit positions. This assignment of bit values or labels to bit positions in effect results in the bit values being placed onto bit indices in an input vector to which encoding is to be applied (i.e., placed onto subchannels). In some embodiments, specific bit value placement rules are specified. FIG. 11 is a block diagram illustrating bit value placement according to such an embodiment comprising some example bit value placement rules.

Some embodiments involve determining a shortest code block u*₊ that has length larger than K, such as N′ referenced above, to enable self-decodability. Bit values or labels in the bit value or label set L*₊ are assigned to u*₊, which means that those bit values or labels in the bit value or label set L*₊ are assigned to bit indices in I*₊. This assignment may be based on any of various properties or criteria, such as a predefined order. Examples of predefined orders include reliability order and bit index order in u*₊. With a predefined order denoted by

$$r {⋆}_{+} {=}^{△} r ( {i}_{1} ) , r ( {i}_{2} ) … r ( {i}_{K} {*}_{+} ) ,$$

bit values or labels

$$L {*}_{+} {=}^{△} {l}_{1} , {l}_{2} … {l}_{K} {*}_{+}$$

can be assigned to bit indices i₁, i₂ . . . i_{K*+} for encoding, according to this order. It is possible, however, that bit values or labels in the bit value or label set for u*₊ may have already been mapped, in a previous iteration. Any previous mapping is maintained, instead of re-mapping a previously mapped label.

For a complement code block u*₋, the bit value or label set is L*₋, and bit values or labels in the bit value or label set are assigned to u*₋. This assignment may be based on a predefined order such as reliability order or bit index order, for example, in u*₊. The bit values or labels are also mapped to bit indices in I*₋, by another pre-defined order such as reliability order or bit index order in u*₋.

Regarding bit value placement for a complement code block, note that L*₋⊂L*₊, and therefore each bit value or label in L*₋ can also be found in L*₊. Accordingly, each bit value or label in L*₋ has already been associated (assigned) to a bit index in u*₊. As a result, all of the bit values or labels in L*₋ have also already been assigned to bit indices in I*₊, and thus can be ordered by a predefined order in u*₊, denoted by r*₊ above. However, there are only K*₋ elements in L*₋, and therefore only the K*₋ elements in r*₊ that share the same bit values or labels with c*₋ can be extracted or taken to form a shorter sequence. That shorter sequence may be denoted by z*₊ for ease of reference.

The overall bit placement procedure for u*₋ may include two sub-steps or operations, referred to herein as “read out” and “assign to”. Regarding the “read out” sub-step or operation, if the predefined order is denoted by

$$z {⋆}_{+} {=}^{△} r ( {i}_{1} ) , r ( {i}_{2} ) … r ( {i}_{K} {*}_{-} ) ,$$

then the bit values or labels in the set L*₋ can in effect be read out or otherwise determined as

$$L {*}_{-} {=}^{△} {l}_{1} , {l}_{2} … {l}_{K} {*}_{-} ,$$

from the bit value or label assignment for u*₊. Then, if another predefined order for bit value or label assignment to u*₋ is denoted by

$$z {*}_{-} {=}^{△} r ( {i}_{1} ) ,$$

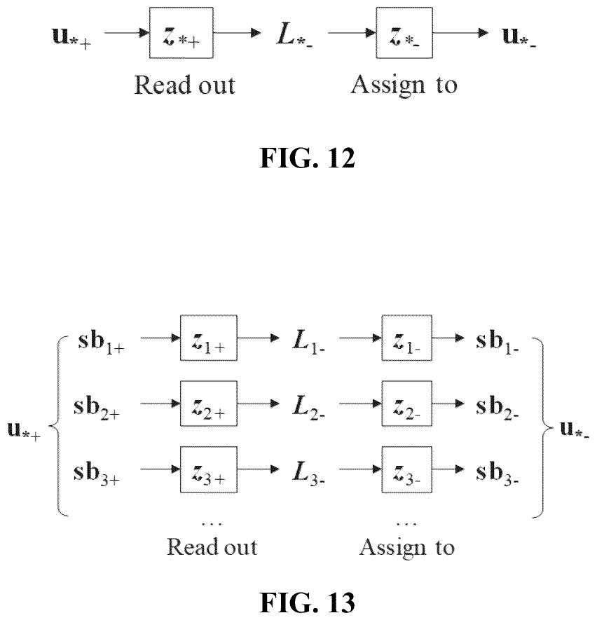

r(i₁), r(i₂) . . . r(i_{K*-}), then the bit values or labels in the set L*₋ from the previous sub-step are assigned to the bit indices i₁, i₂ . . . i_{K*-} (in u*₋) according to the z*₋ order. FIG. 12 is a block diagram illustrating this type of bit value placement.

For a next iteration, u*=[u*₋, u*₊] is treated as a new u*₊, and operations as outlined above, starting with bit values or labels in the bit value or label set L*₊ being assigned to the new u*₊, are repeated.

The orders r and z above may be chosen or otherwise obtained based on any of various parameters or criteria, such as specific coding applications for example. It should be noted that the orders for “read out” and “assign to” can be based on different rules. For example, “read out” may be performed using one rule, and “assign to” may be performed using a different rule.

In the following examples, both ascending and descending orders are allowed. Other variations are also possible. These examples, like others herein, are illustrative and non-limiting.

A first example involves bit value or label assignment according to reliability, in a

$${Q}_{1}^{{N}_{max}}$$

sequence, for example, where Qᵢ denotes a reliability order of an i-th bit in an Nₘₐₓ-length mother code. A subset of

$${Q}_{1}^{{N}_{max}} ,$$

i.e., Q(i₁), Q(i₂) . . . Q(i_{K*}), where only bit indices that are to be assigned are extracted, may be used.

Another example relates to bit value or label assignment according to bit index, such as [1, 2, 3 . . . Nₘₐₓ], where the indices are bit indices of the subchannels in a mother code. A subset i₁, i₂ . . . i_{K*}, where only the indices to be assigned are extracted, may be used.

Bit value or label assignment according to code bit interleaving (after encoding) is also possible, based on a

$${π}_{1}^{{N}_{max}}$$

sequence, where πᵢ denotes a position of an i-th code bit in the mother code after interleaving, for example. A subset i₁, i₂ . . . i_{K*}, where only the indices to be assigned are extracted, may be used.

Another example relates to bit value or label assignment according to transmission order, such as a

$${T}_{1}^{{N}_{max}}$$

sequence where Tᵢ denotes an order in which an i-th code bit is to be transmitted after encoding. A subset i₁, i₂ . . . i_{K*}, where only the indices to be assigned are extracted, may be used.

Some embodiments may provide partition-based bit value or label assignment, to allow finer-grained partitions within u*₋ and u*₊ and bit value or label assignment within partitions.

For example, one partition-based bit value or label assignment approach involves partitioning u*₋ into equal-sized subblocks (sb₁₋, sb₂₋, sb₃₋, . . . ), determining the number of information bits in these subblocks (K₁, K₂, K₃, . . . ), and partitioning u*₊ into subblocks (sb₁₊, sb₂₊, sb₃₊, . . . ) with the same numbers of information bits (K₁, K₂, K₃, . . . ). Sorting of information bit positions according to a predefined order such as any of the examples provided above may be performed before the partitioning. This approach may be referred to as an “equal code bits −” approach, referring to partitioning u*₋ into equal-sized subblocks.

Another possible approach, which may be referred to as an “equal code bits +” approach, involves partitioning u*₊ into equal-sized subblocks (sb₁₊, sb₂₊, sb₃₊, . . . ), determining the number of information bits in these subblocks (K₁, K₂, K₃, . . . ), and partitioning u*₋ into subblocks (sb₁₋, sb₂₋, sb₃₋, . . . ) with the same numbers of information bits (K₁, K₂, K₃, . . . ). Again, sorting of information bit positions according to a predefined order such as any of the examples provided above may be performed before the partitioning.

In another approach, which may be referred to as an “equal information bits” approach, u*₋ and u*₊ are each partitioned into subblocks sb₁₊, sb₂₊, sb₃₊, . . . , and sb₁₋, sb₂₋, sb₃₋, . . . , respectively, such that all of the subblocks have an equal number of information bits in their shared bit value or label set L*₋. As in the other example partition-based assignment approaches above, sorting of information bit positions according to a predefined order such as any of the examples provided above may be performed before the partitioning.

Partition-based assignment may involve two sub-steps or operations that are referenced above as “read out” and “assign to”. FIG. 13 is a block diagram illustrating bit value placement according to such an embodiment. Bit values or labels for sbᵢ₊ may be read out and assigned to sbᵢ₋ according to predefined orders as shown by way of example, for all subblocks. The “read out” and “assign to” sub-steps or operations may be substantially the same as described above, but are performed for each of multiple subblocks in the example shown in FIG. 13.

Read-out and assign-to orders, along with partitioning parameters such as number of partitions and partitioning methods, can be specified in communication standards or specifications for example, to facilitate implementation and improve performance. Several examples are provided in Table 1 below.

TABLE 1
Example Orders

| | | Partition (number, |
|---|---|---|
| Read-out order | Assign-to order | method) |
| Reliability | Reverse bit index | (1, N/A) |
| Reliability | Transmission | (4, Equal code bits —) |
| Bit index | Reverse bit index | (1, N/A) |
| Bit index | Transmission | (4, Equal code bits —) |

A mapping sequence may also or instead be defined in a communication standard or specification, or generated according to a procedure specified by such a standard or specification, for example. Online generation of such a mapping sequence is one possible option, and a mapping sequence may be generated based on any of one or more parameters such as a reliability sequence, an interleaving sequence, transmission order, etc.

As an illustrative example, a mapping sequence for a (64,32) polar code is described in Table 2 below. Table entries in odd-numbered rows (first, third, fifth, and seventh rows, in italic) are bit indices, and table entries in even-numbered rows (second, fourth, sixth, and eighth rows, in bold are labels or indices (or other identifiers) of bit values. As shown, several bit values or labels (8, 11, 1, 13, 4, 15, 17, 26) appear multiple times and are shared by multiple bit indices.

TABLE 2
Example Mapping Sequence

| 1 | 2 | 3 | 4 | 5 | 6 | 7 | 8 | 9 | 10 | 11 | 12 | 13 | 14 | 15 | 16 |
|---|---|---|---|---|---|---|---|---|---|---|---|---|---|---|---|
| 0 | 0 | 0 | 0 | 0 | 0 | 0 | 0 | 0 | 0 | 0 | 0 | 0 | 0 | 0 | 8 |
| 17 | 18 | 19 | 20 | 21 | 22 | 23 | 24 | 25 | 26 | 27 | 28 | 29 | 30 | 31 | 32 |
| 0 | 0 | 0 | 0 | 0 | 0 | 0 | 11 | 11 | 8 | 1 | 13 | 4 | 15 | 17 | 26 |
| 33 | 34 | 35 | 36 | 37 | 38 | 39 | 40 | 41 | 42 | 43 | 44 | 45 | 46 | 47 | 48 |
| 8 | 11 | 1 | 13 | 4 | 15 | 2 | 14 | 17 | 3 | 5 | 16 | 7 | 18 | 20 | 27 |
| 49 | 50 | 51 | 52 | 53 | 54 | 55 | 56 | 57 | 58 | 59 | 60 | 61 | 62 | 63 | 64 |
| 26 | 6 | 9 | 19 | 10 | 21 | 22 | 28 | 12 | 23 | 24 | 29 | 25 | 30 | 31 | 32 |

As seen, there is no fixed “rate allocation” between the first length-32 subblock and the second length-32 subblock, because the bit value or label sets |L⁻| and |L⁺| are assigned to the two subblocks, rather than allocating information bits. Even if all bits or positions with label l>0 are considered information bits, in this example |L|=32, |L⁻|=8, and |L⁺|=32. Clearly, |L|<|L⁻|+|L⁺|, which is different from conventional rate allocation according to which K=K⁻+K⁺.

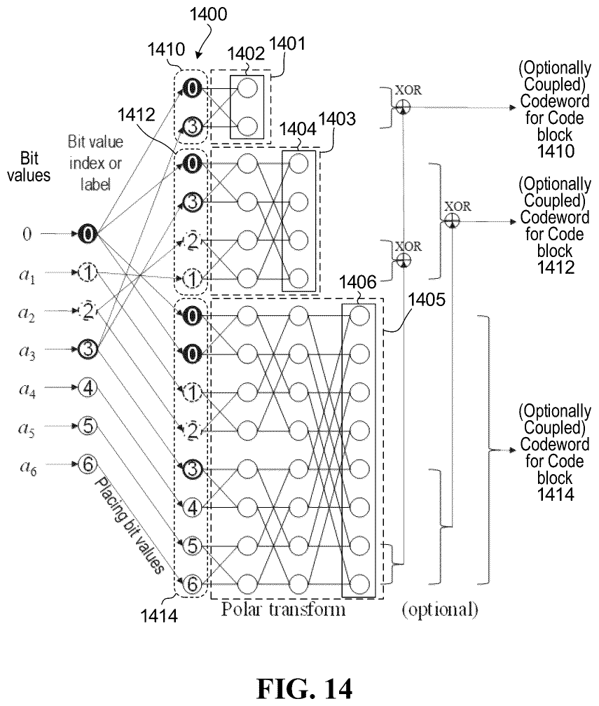

Various embodiments are described in detail at least above. FIG. 14 is a block diagram illustrating an example trellis graph and several features according to embodiments disclosed herein.

In FIG. 14, the numbers in column 1400 are bit value indices or other identifiers of bit values, or labels in some embodiments, and several bit indices in column 1400 share the same bit values, indexed or labeled 0 (frozen), 1, 2, 3 as shown. The other bit values indexed or labeled 4, 5, 6 are one-to-one mapped. As in other embodiments, labels are optional, and bit value placement as illustrated in FIG. 14 may be provided with or without using labels.

Bits are encoded in the example shown by three polar transformations 1401, 1403, 1405 to generate a long codeword that includes three shorter codewords 1402, 1404, and 1406, generated from three shorter code blocks 1410, 1412, 1414. Because each of the three shorter code blocks 1410, 1412, 1414 include at least one same or common bit value, the same common bit value creates a relationship that effectively couples the resultant three shorter codewords 1402, 1404, and 1406. The three shorter codewords 1402, 1404, and 1406 may optionally be further coupled by subsequent XOR operations, as shown in this example, to strengthen the relationship between codewords and further couple them together.

The three shorter codewords 1402, 1404, and 1406, in FIG. 14 are of length 2, 4 and 8 respectively, and are illustrated before optional coupling. FIG. 14 also illustrates combining of the shorter codewords 1402, 1404 with parts of longer codewords. For example, the codeword 1402 of length 2 is optionally combined with the last two bits of the length-4 codeword 1404 and the last two bits of the length-8 codeword 1406, and the length-4 codeword 1404 is optionally combined with the last four bits of the length-8 codeword 1406. The length-8 codeword 1406 is self-decodable because its corresponding code block 1414 contains all of the bit values from the input bit sequence.

In IR-HARQ, for example, the length-8 codeword 1406 might be transmitted as an initial transmission, the length-4 codeword 1404 may be transmitted in a retransmission, and the length-2 codeword 1402 may be transmitted in a final retransmission. If the length-8 codeword 1406 is self-decodable, then it may be possible to decode that codeword first, and avoid any retransmissions if decoding is successful. Self-decodability of the length-8 codeword 1406 in this example may also or instead enable selective or opportunistic decoding of the length-4 codeword 1404 (and/or the length-2 codeword 1402), which may be much less reliable.

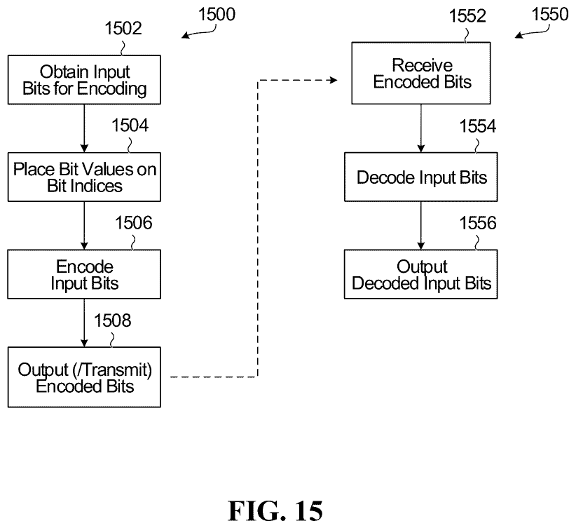

Various aspects of the present disclosure are described above and shown in the drawings by way of example. FIG. 15 is a flow diagram illustrating more general example methods according to embodiments. At the left, 1500 in FIG. 15 illustrates operations or features that may be provided or supported at an encoder or transmitter-side device that in some embodiments may be or include an apparatus as shown by way of example in FIG. 6A. At the right, 1550 illustrates operations or features that may be provided or supported at a decoder or receiver-side device that may include, for example, an interface and a decoder coupled to the interface. For ease of reference, in the following description of FIG. 15, a device at which encoding and/or transmitting features may be implemented or supported is called a first communication device, and a device at which decoding and/or receiving features may be implemented or supported is called a second communication device. Embodiments may involve either or both of such devices.

With reference first to 1500, from a transmitting device perspective the outputting of encoded bits may involve transmitting the encoded bits at 1508. Encoded bits may be output through or via any of various types of interface, including a communication interface in the case of transmitting the encoded bits. Embodiments are not in any way restricted to any particular type of interface. The encoded bits may be transmitted by a first communication device to a second communication device in a wireless communication network, for example. The encoded bits are obtained by encoding input bits by a polar code at 1504, by a polar encoder 604 (FIG. 6A) for example, and may be referred to as encoded bits encoded by the polar code.

The polar code comprises or provides bit indices for placing values of the input bits before encoding. The bit indices include: a first set of bit indices for placing values of a first subset of the input bits, a second set of bit indices for placing values of a second subset of the input bits, and a third set of bit indices for placing a predetermined bit value. Bit value placement is shown at 1504 in FIG. 15, but may be considered to be part of the encoding at 1506. Similarly, with reference again to the example apparatus in FIG. 6A, in some embodiments the encoding bit value selector 602 may be configured for placing bit values on bit indices, or the polar encoder 604 may be configured for placing bit values on bit indices without an encoding bit value selector. Each value of the first subset of the input bits is placed, by an encoding bit index selector or a polar encoder for example, on one bit index of the first set of bit indices (also referred to herein as one-to-one mapping), and each value of the second subset of the input bits is placed, by an encoding bit index selector or a polar encoder for example, on two or more bit indices of the second set of bit indices (also referred to herein as one-to-many or many-to-one mapping).

Regarding placement of a bit value on one bit index or on two or more bit indices, each bit index on which a bit value is placed provides a decoding opportunity for that bit value. Generally speaking, the more bit indices on which the same bit value is placed, the higher the likelihood of correct decoding of that bit value because there are more decoding opportunities for that bit value.

As an example, with reference to FIG. 9, consider a scenario in which the blocks in the top row, from left to right, represent code blocks corresponding to encoded bits that are transmitted in a series of transmissions in an incremental redundancy hybrid automatic repeat request (IR-HARQ) approach. The initial transmission might include encoded bits corresponding to the rightmost u₊₊₊₊ block only, for which it is expected that each input bit value would have been placed on only one bit index for encoding. Additional encoded bits corresponding to the next u₊₊₊₋ block might be transmitted in an initial transmission with the encoded bits corresponding to the rightmost u₊₊₊₊ block, and at least some of the input bit values placed on bit indices in the u₊₊₊₊ block are also placed on bit indices in the u₊₊₊₋ block. Considering these u₊₊₊₊ and u₊₊₊₋ blocks together, some of the input bit values (of the first subset of input bits referenced above) are placed on one bit index, and other input bit values (of the second subset referenced above) are placed on two or more bit indices. Similar comments apply to the other code blocks, and across all code blocks there are at least some input bit values that are placed on two or more bit indices.

A next transmission or retransmission may include encoded bits corresponding to the u₊₊₋ code block in FIG. 9, and so on, until an entire longer codeword including all encoded bits corresponding to all code blocks have been transmitted, or all input bits have been correctly decoded, for example. For each such transmission or retransmission, the likelihood of correct decoding increases due to the fact that incrementally transmitted encoded bits provide another opportunity to decode at least some input bit values.

The number of bit indices on which bit values of input bits in the second subset referenced above are placed, at 1504, may depend upon any of various factors or conditions. For example, with continued reference to FIG. 9, one factor or condition may be the smallest transmitted code length. If the smallest transmitted code length (referred to as N′ above) is Nₘₐₓ (mother code length)/2, corresponding to one step or level of recursion based on dividing or partitioning by one half at a time as shown in FIG. 9, then it is likely that bit values of input bits in the second subset are placed on at most two bit indices. With shorter transmitted code length relative to longest transmitted code length, the likelihood of bit value placement on more than two bit indices (for higher probability of correct decoding) is higher because overall there are more bit indices available for placement of input bit values.

Turning again to FIG. 15, another operation that may be involved in obtaining encoded bits is illustrated at 1502. Obtaining input bits may involve, for example, collecting or otherwise receiving data outputs from one or more devices and/or services, or accessing data in a memory.

As shown at 1508, a method may also involve outputting the encoded bits that were obtained at 1506. The encoded bits may be output for storage to memory, and/or transmission as indicated at 1508 for example. In the example apparatus shown in FIG. 6A, encoded bits may be output by the polar encoder 604 through or via an interface, or by the rate matching module 606 through or via an interface if rate matching is performed to reduce the number of encoded bits.

Embodiments may include any or all of the operations illustrated at 1500. For example, in some embodiments, a method may involve bit value placement (by the encoding bit value selector 602 or the polar encoder 604 for example) and encoding (by the polar encoder 604 for example) as shown at 1504 and 1506, and transmitting or otherwise outputting the encoded bits (by the polar encoder 604 or the rate matching module 606 for example) at 1508. Other embodiments may involve transmitting or otherwise outputting, at 1508, encoded bits that have already been obtained by encoding input bits by a polar code. Such embodiments are not mutually exclusive, and methods may involve the obtaining, placing, and encoding as shown at 1502, 1504, 1506, and also outputting encoded bits as shown at 1506.

Other features may also or instead be provided or supported.

For example, each value of the second subset of the input bits that is placed at 1504 on the two or more bit indices of the second set enables the input bit value to be known for all of the respective two or more bit indices after the input bit value is decoded for any one of the two or more bit indices. This is an example of an encoding or transmitting method feature (bit value placement, by the encoding bit value selector 602 or the polar encoder 604 for example) that enables or supports a decoding or receiving method feature (decoding any one of the two or more bit indices).

The bit indices provided by a polar code may be associated with multiple code blocks. Examples are provided elsewhere herein, and are also shown at least in FIGS. 7 to 10 and 14. In such embodiments, the second set of bit indices may include bit indices associated with more than one of those code blocks, such as the “+” and “−” code blocks referenced herein.

Regarding code block coupling or nesting, input bit values of the second subset of the input bits may be placed, at 1504, by the encoding bit value selector 602 or the polar encoder 604 for example, on both bit indices associated with a first code block and bit indices associated with a second code block of the plurality of code blocks, to thereby couple the code blocks, and corresponding codewords, together. As discussed in detail above, this is one way to couple code blocks and codewords to each other.

In some embodiments, a method may involve combining first encoded bits, which are obtained by encoding, at 1506 by the polar encoder 604 for example, the first code block or otherwise correspond to bits of the first code block, with second encoded bits that are obtained by encoding, at 1506, the second code block or otherwise corresponding to bits of the first code block, to obtain a coupled codeword. This type of codeword coupling, by combining encoded bits that may include all encoded bits or a subset of encoded bits of a codeword, is described by way of example with reference to combining via one or more XOR operations. Examples are also shown, in FIGS. 7 and 14. Codeword coupling may be implemented, for example, by the polar encoder 604 or by another component that is coupled to an encoder and configured to combine encoded bits.

Input bit values may be recursively divided (by the encoding bit value selector 602 or the polar encoder 604 for example), in multiple iterations, among code blocks. The example shown in FIG. 8 involves a single iteration, and the examples in FIGS. 9 and 10 involve multiple iterations. The code blocks at each iteration include a shorter code block (the “+” code block in examples described above) that includes all input bit values of a longer code block from which the shorter code block is divided at the iteration.

The code blocks may include a code block in which respective input bit values are uniquely placed, at 1504, on a respective bit index of the plurality of bit indices, or in other words a code block in which no input bit value is placed on more than one bit index. Mappings are one-to-one only in such a code block. In an example above referring to FIG. 9 and initial transmission of encoded bits corresponding to the rightmost “+” code block, the initial transmission corresponds to this type of codeword with input bit values uniquely mapped to only one bit index associated with the code block.

Code blocks may also or instead include a code block in which respective input bit values are uniquely placed, at 1504 (by the encoding bit value selector 602 or the polar encoder 604 for example), on respective consecutive bit indices in a first part of the code block, and respective input bit values are uniquely placed, at 1504 (by the encoding bit value selector 602 or the polar encoder 604 for example), on respective consecutive bit indices in a second part of the code block. These parts of a code block may be an upper part (higher bit indices in a second half of the code block, also referred to as u-code, or plus-code) of and a lower part (lower bit indices in a first half of the code block, also referred to as v-code). With the unique placement on respective consecutive bit indices of each part as referenced above, encoded bits corresponding to the first part (e.g., u-code) might not contain any one-to-many mappings of input bit values, but there may be one or more input bit values mapped to both the first part and the second part (e.g., v-code). Thus, the respective input bit values placed, at 1504 (by the encoding bit value selector 602 or the polar encoder 604 for example), on the respective consecutive bit indices in the first part of the code block and the respective input bit values placed, at 1504 (by the encoding bit value selector 602 or the polar encoder 604 for example), on the respective consecutive bit indices in the second part of the code block may each include a value of an input bit of the second subset of the input bits, placed on both a bit index in the first part of the code block and a bit index in the second part of the code block.

For example, suppose that an initial transmission length is 6, for which the shortest power-of-2 mother code length and code block length is 8. Denoting the bit indices in the length 8 code block [1,2,3,4,5,6,7,8], in the unique bit value placement example above there are no one-to-many mapping within [5,6,7,8]. In other words, bit values or labels placed on or assigned to [5,6,7,8] are distinct. However, there can be one or more bit values or labels placed on or assigned to bit indices in both [1,2,3,4] and [5,6,7,8]. That is, there may be bit value or label sharing between the two halves, or more generally two parts, of a code block even when there is no such sharing or common bit value or label within each part individually.

Code blocks may include a code block in which a value of an input bit of the second subset of the input bits is placed on two or more bit indices. For example, in an embodiment a code block other than a shortest code block corresponding to a rate-1 (or highest-rate) transmitted code length may contain one-to-two or one-to-many mappings according to which each of one or more input bit values is mapped to two or more bit indices. Regarding a rate-1 code block corresponding to a rate-1 codeword, such a code block cannot have anything other than one-to-one mappings. If code rate is 1, then the number of bit indices is the same as the number of input bits and input bit values. All bit indices are therefore uniquely mapped to a respective one of the input bit values, and there are not enough bit indices available to place any single input bit value on multiple bit indices. In other words, each bit index has a distinct input bit value or label, and there is no room for bit value or label sharing within that code block.

In an iterative approach, at each iteration only the shorter code block that includes all of the input bit values of the longer code block from which the shorter code block is divided might be further divided into multiple shorter code blocks. This is consistent with FIG. 9, for example, in which only the “+” code block at each iteration is further divided in a next iteration.

According to another embodiment, at each iteration multiple shorter code blocks into which a longer code block from a previous iteration are divided are each further divided into multiple further shorter code blocks. This is consistent with FIG. 10, for example, in which both the “−” and “+” code block at each iteration are further divided in a next iteration. The multiple further shorter code blocks into which each code block is divided include a further shorter code block that includes all input bit values of the shorter code block from which the further shorter code block is further divided (the “+” shorter code block), as well as another shorter code block (the “−” shorter code block) that includes a subset of those input bit values.

Some embodiments involve bit labeling and labels. Encoding may therefore involve assigning values of the input bits and the predetermined bit value to respective labels that are associated with the bit indices, and assigning the values of the input bits and the predetermined bit value of the respective labels to the bit indices. Bit value placement in labeling embodiments may involve these assigning operations. The encoding bit value selector 602 or the polar encoder 604, for example, may be configured to assign values of the input bits and the predetermined bit value to respective labels that are associated with the bit indices. Similarly, the encoding bit value selector 602 or the polar encoder 604, for example, may be configured to assign the values of the input bits and the predetermined bit value of the respective labels to the bit indices.

The labels include, among other labels, a subset of labels associated with the second set of bit indices for assigning each respective value of the second subset of the input bits to the respective two or more bit indices of the second set of bit indices. The labels may also include a single label, to which the predetermined bit value is assigned, and that is associated with all of the bit indices in the third set of bit indices.

The labels may be associated with the bit indices based on any of various criteria or conditions, including one or more of the following for example: a reliability order, a bit index order, a code bit interleaving sequence, a transmission order, and a predefined order for one subset of the bit indices that is based on an order for a different subset of the bit indices. More generally, bit value placement on bit indices may be based on any of these, and/or one or more other criteria or conditions. Examples are provided elsewhere herein, including with reference to FIGS. 11 to 13.

Embodiments that use labels may also involve obtaining the labels from a mapping sequence. The mapping sequence, in the case of labels, is for indicating an association of respective labels to bit indices. More generally, bit value placement may be based on a mapping sequence that is for indicating an association of bit values to bit indices.

Embodiments may involve other features or operations that are not explicitly shown in FIG. 15. For example, some embodiments may involve communicating signaling that is indicative of any of various parameters, such as any one or more of: MCS index, code length, code rate, mapping sequence. Communicating of signaling may involve transmitting the signaling by an encoder/encoding device or a transmitter/transmitting device that is to transmit encoded bits, to a decoder/decoding device or a receiver/receiving device. The communicating may also or instead involve receiving the signaling by a decoder/decoding device or a receiver/receiving device from an encoder/encoding device or a transmitter/transmitting device. Signaling need not necessarily be between, or only between, communication devices by which encoded bits are to be transmitted or received. For example, a network device such as a gNB or a base station may transmit signaling to configure parameters at one or more communication devices. Therefore, a method may involve a network device transmitting signaling, and an encoder/encoding device or a transmitter/transmitting device receiving the signaling from the network device, and/or a decoder/decoding device or a receiver/receiving device receiving the signaling from the network device.

At 1550, FIG. 15 illustrates various decoding and/or receiving counterparts of features shown at 1500. From a receiving device perspective, the receiving at 1552 is represents receiving encoded bits that have been encoded by a polar code. The receiving may involve receiving the encoded bits from a first communication device by a second communication device in a wireless communication network, for example. Encoded bits may be received through or via any of various types of interface, and embodiments are not in any way restricted to any particular type of interface.

The polar code, as in other embodiments herein, comprises bit indices for placing values of input bits before encoding, and the bit indices include a first set of bit indices for placing values of a first subset of the input bits, a second set of bit indices for placing values of a second subset of the input bits, and a third set of bit indices for a predetermined bit value. For encoding, each value of the first subset of the input bits would have been placed on one bit index of the first set of bit indices, and each value of the second subset of the input bits would have been placed on two or more bit indices of the second set of bit indices.

The decoding at 1554 is intended to illustrate decoding the received encoded bits to obtain decoded input bits. In some embodiments, a decoder might not be a discrete device, but rather a block of logic in silicon or part of a system-on-chip that decodes and uses the decoded input bits. In other embodiments, the decoded input bits are output as shown at 1556, for processing and/or storage, for example.

Any or all of the features that are described above in the context of encoder-side or transmitter-side methods, with reference to operations at 1500 in FIG. 15, for example, may also apply to or have counterpart features in a decoder-side or receiver-side method. Any one or more of the following features, for example, may be provided or supported, individually or in any of various combinations, in a decoder-side or receiver-side method:
the decoding at 1554 involves, for each value of the second subset of the input bits that is placed on the two or more bit indices, decoding the input bit value for any one of the two or more bit indices;
the bit indices are associated with a plurality of code blocks;
the second set of bit indices include bit indices associated with multiple code blocks of the plurality of code blocks;
input bit values of the second subset of the input bits are placed on both bit indices associated with a first code block of the plurality of code blocks and bit indices associated with a second code block of the plurality of code blocks;
the encoded bits comprise a coupled codeword that includes first encoded bits obtained by encoding the first code block combined with second encoded bits obtained by encoding the second code block;
the input bit values have been recursively divided, in multiple iterations, among a plurality of code blocks;
the plurality of code blocks at each iteration comprised a shorter code block that included all input bit values of a longer code block from which the shorter code block was divided at the iteration;
the plurality of code blocks includes a code block in which respective input bit values have been uniquely placed on a respective bit index of the plurality of bit indices; the plurality of code blocks includes a code block in which respective input bit values have been uniquely placed on respective consecutive bit indices in a first part of the code block and respective input bit values have been uniquely placed on respective consecutive bit indices in a second part of the code block;
the respective input bit values that have been placed on the respective consecutive bit indices in the first part of the code block and the respective input bit values that have been placed on the respective consecutive bit indices in the second part of the code block each include a value of an input bit of the second subset of the input bits placed on both a bit index in the first part of the code block and a bit index in the second part of the code block;
the plurality of code blocks includes a code block in which a value of an input bit of the second subset of the input bits has been placed on two or more bit indices of the plurality of bit indices;
at each iteration, only the shorter code block that included all of the input bit values of the longer code block from which the shorter code block was divided was further divided into multiple shorter code blocks;
at each iteration multiple shorter code blocks into which a longer code block from a previous iteration was divided were each further divided into multiple further shorter code blocks;
the multiple further shorter code blocks into which each shorter code block was divided included a further shorter code block that included all input bit values of the shorter code block from which the further shorter code block was further divided;
respective labels are associated with the plurality of bit indices;
the values of the input bits and the predetermined input bit value have been placed on the plurality of bit indices by assigning the values of the input bits and the predetermined bit value to the respective labels, and assigning the values of the input bits and the predetermined bit value of the respective labels to the plurality of bit indices,
the labels include a subset of labels associated with the second set of bit indices for assigning each respective value of the second subset of the input bits to the respective two or more bit indices of the second set of bit indices;
the labels are associated with the bit indices based on any one or more of: a reliability order, a bit index order, a code bit interleaving sequence, a transmission order, and a predefined order for one subset of the bit indices that is based on an order for a different subset of the bit indices;
the labels further include a single label, to which the predetermined bit value has been assigned, and that is associated with all of the bit indices in the third set of bit indices;
a method may involve obtaining the respective labels from a mapping sequence for indicating an association of the respective labels to the plurality of bit indices.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

An apparatus may include a processor that is configured, by executing programming for example, to cause the apparatus to perform a method or operations, or to provide or support features, disclosed herein. An apparatus may also include a non-transitory computer readable storage medium, coupled to the processor, storing programming for execution by the processor. In FIG. 3, for example, the processors 210, 260, 276 may each be or include one or more processors, and each memory 208, 258, 278 is an example of a non-transitory computer readable storage medium, in an ED 110 and a TRP 170, 172. A non-transitory computer readable storage medium need not necessarily be provided only in combination with a processor, and may be provided separately in a computer program product, for example.

As an illustrative example, programming stored in or on a non-transitory computer readable storage medium may include instructions to or to cause a processor to encode input bits by a polar code to obtain encoded bits, and output the encoded bits. Apparatus embodiments are not limited to programming-based embodiments. An apparatus may also or instead include an encoder for encoding input bits by a polar code to obtain encoded bits, and an interface coupled to the encoder for outputting the encoded bits. The polar code comprises a plurality of bit indices for placing values of the input bits before encoding. The bit indices include a first set of bit indices for placing values of a first subset of the input bits, a second set of bit indices for placing values of a second subset of the input bits, and a third set of bit indices for placing a predetermined bit value. Each value of the first subset of the input bits is placed on one bit index of the first set of bit indices, and each value of the second subset of the input bits is placed on two or more bit indices of the second set of bit indices.

More generally, an apparatus or a component thereof such as an encoder or a processor may be configured to, or programming may include instructions to or to cause a processor to, encode input bits to obtain encoded bits. Such an apparatus or a component thereof such as an interface may be configured to, or programming may include instructions to or to cause a processor to, output encoded bits, by transmitting the encoded bits by a first communication device to a second communication device in a wireless communication network for example.

Embodiments related to such apparatus or non-transitory computer readable storage media may include any one or more of the following features, for example, which are also discussed elsewhere herein:
each value of the second subset of the input bits that is placed on the two or more bit indices of the second set, by the encoding input index selector 602 or the polar encoder 604 for example, enables the input bit value to be known for all of the respective two or more bit indices after the input bit value is decoded for any one of the two or more bit indices;
the plurality of bit indices is associated with a plurality of code blocks;
the second set of bit indices comprises bit indices associated with multiple code blocks of the plurality of code blocks;
input bit values of the second subset of the input bits are placed, by the encoding input index selector 602 or the polar encoder 604 for example, on both bit indices associated with a first code block of the plurality of code blocks and bit indices associated with a second code block of the plurality of code blocks;
an apparatus or a component thereof such as an encoder or a processor may be further configured to, or programming may include instructions to or to cause a processor to: combine first encoded bits obtained by encoding the first code block with second encoded bits obtained by encoding the second code block to obtain a coupled codeword;
the input bit values are recursively divided, in multiple iterations, among a plurality of code blocks by the encoding input index selector 602 or the polar encoder 604 for example;
the plurality of code blocks at each iteration include a shorter code block that includes all input bit values of a longer code block from which the shorter code block is divided at the iteration;
the plurality of code blocks includes a code block in which respective input bit values are uniquely placed (by the encoding input index selector 602 or the polar encoder 604 for example) on a respective bit index of the plurality of bit indices;
the plurality of code blocks includes a code block in which respective input bit values are uniquely placed (by the encoding input index selector 602 or the polar encoder 604 for example) on respective consecutive bit indices in a first part of the code block and respective input bit values are uniquely placed (by the encoding input index selector 602 or the polar encoder 604 for example) on respective consecutive bit indices in a second part of the code block;
the respective input bit values placed (by the encoding input index selector 602 or the polar encoder 604 for example) on the respective consecutive bit indices in the first part of the code block and the respective input bit values placed (by the encoding input index selector 602 or the polar encoder 604 for example) on the respective consecutive bit indices in the second part of the code block each include a value of an input bit of the second subset of the input bits placed (by the encoding input index selector 602 or the polar encoder 604 for example) on both a bit index in the first part of the code block and a bit index in the second part of the code block;
the plurality of code blocks includes a code block in which a value of an input bit of the second subset of the input bits is placed (by the encoding input index selector 602 or the polar encoder 604 for example) on two or more bit indices of the plurality of bit indices;
at each iteration, only the shorter code block that includes all of the input bit values of the longer code block from which the shorter code block is divided is further divided (by the encoding input index selector 602 or the polar encoder 604 for example) into multiple shorter code blocks;
at each iteration multiple shorter code blocks into which a longer code block from a previous iteration are divided are each further divided (by the encoding input index selector 602 or the polar encoder 604 for example) into multiple further shorter code blocks;
the multiple further shorter code blocks into which each shorter code block is divided (by the encoding input index selector 602 or the polar encoder 604 for example) include a further shorter code block that includes all input bit values of the shorter code block from which the further shorter code block is further divided;
an apparatus or a component thereof such as an encoding bit index selector 602, an encoder 604, or a processor may be configured to, or programming may include instructions to or to cause a processor to: encode the input bits by assigning the values of the input bits and the predetermined bit value to respective labels that are associated with the plurality of bit indices, and assigning the values of the input bits and the predetermined bit value of the respective labels to the plurality of bit indices;
the labels include a subset of labels associated with the second set of bit indices for assigning each respective value of the second subset of the input bits to the respective two or more bit indices of the second set of bit indices;
the labels further include a single label, to which the predetermined bit value is assigned, and that is associated with all of the bit indices in the third set of bit indices;
an apparatus or a component thereof such as an encoder may be configured to, or programming may include instructions to or to cause a processor to: obtain the respective labels from a mapping sequence for indicating an association of the respective labels to the plurality of bit indices.

For a decoder-side or receiver-side apparatus or a computer program product comprising a non-transitory computer readable storage medium to support decoder-side or receiver-side operations, the apparatus may be configured to or programming may include instructions to, or to cause a processor to: receive encoded bits that have been encoded by a polar code, and decode the encoded bits to obtain decoded input bits. In another embodiment, an apparatus includes an interface for receiving encoded bits that have been encoded by a polar code, and a decoder coupled to the interface, for decoding the encoded bits to obtain decoded input bits. The polar code comprises a plurality of bit indices for placing values of input bits before encoding, and the bit indices include a first set of bit indices for placing values of a first subset of the input bits, a second set of bit indices for placing values of a second subset of the input bits, and a third set of bit indices for a predetermined bit value. For encoding, each value of the first subset of the input bits would have been placed on one bit index of the first set of bit indices, and each value of the second subset of the input bits would have been placed on two or more bit indices of the second set of bit indices.

Embodiments related to such apparatus or non-transitory computer readable storage media may include any one or more of the following features, for example, which are also discussed elsewhere herein:
an apparatus or a component thereof such as an interface or processor may be configured to, or programming may include instructions to or to cause a processor to: receive the encoded bits from a first communication device by a second communication device in a wireless communication network;
an apparatus or a component thereof such as a decoder or processor may be configured to, or programming may include instructions to or to cause a processor to: for each value of the second subset of the input bits that is placed on the two or more bit indices, decode the input bit value for any one of the two or more bit indices;
the plurality of bit indices is associated with a plurality of code blocks;
the second set of bit indices includes bit indices associated with multiple code blocks of the plurality of code blocks;
input bit values of the second subset of the input bits are placed on both bit indices associated with a first code block of the plurality of code blocks and bit indices associated with a second code block of the plurality of code blocks;
the encoded bits comprise a coupled codeword that includes first encoded bits obtained by encoding the first code block combined with second encoded bits obtained by encoding the second code block;
the input bit values have been recursively divided, in multiple iterations, among a plurality of code blocks;
the plurality of code blocks at each iteration included a shorter code block that included all input bit values of a longer code block from which the shorter code block was divided at the iteration;
the plurality of code blocks includes a code block in which respective input bit values have been uniquely placed on a respective bit index of the plurality of bit indices;
the plurality of code blocks includes a code block in which respective input bit values have been uniquely placed on respective consecutive bit indices in a first part of the code block and respective input bit values have been uniquely placed on respective consecutive bit indices in a second part of the code block;
the respective input bit values that have been placed on the respective consecutive bit indices in the first part of the code block and the respective input bit values that have been placed on the respective consecutive bit indices in the second part of the code block each include a value of an input bit of the second subset of the input bits placed on both a bit index in the first part of the code block and a bit index in the second part of the code block;
the plurality of code blocks includes a code block in which a value of an input bit of the second subset of the input bits has been placed on two or more bit indices of the plurality of bit indices;
at each iteration, only the shorter code block that included all of the input bit values of the longer code block from which the shorter code block was divided was further divided into multiple shorter code blocks;
at each iteration multiple shorter code blocks into which a longer code block from a previous iteration was divided were each further divided into multiple further shorter code blocks;
the multiple further shorter code blocks into which each shorter code block was divided included a further shorter code block that included all input bit values of the shorter code block from which the further shorter code block was further divided;
respective labels are associated with the plurality of bit indices;
the values of the input bits and the predetermined input bit value have been placed on the plurality of bit indices by assigning the values of the input bits and the predetermined bit value to the respective labels, and assigning the values of the input bits and the predetermined bit value of the respective labels to the plurality of bit indices;
the labels include a subset of labels associated with the second set of bit indices for assigning each respective value of the second subset of the input bits to the respective two or more bit indices of the second set of bit indices;
the labels are associated with the plurality of bit indices based on any one or more of: a reliability order, a bit index order, a code bit interleaving sequence, a transmission order, and a predefined order for one subset of the bit indices that is based on an order for a different subset of the bit indices;
the labels further include a single label, to which the predetermined bit value has been assigned, and that is associated with all of the bit indices in the third set of bit indices;
an apparatus or a component thereof such as a decoder may be configured to, or programming may include instructions to or to cause a processor to: obtain the respective labels from a mapping sequence for indicating an association of the respective labels to the plurality of bit indices.

Apparatus embodiments are not in any way restricted to single devices. A system, for example, may include a first communication device and a second communication device. The first communication device may be configured to transmit encoded bits that have been encoded by a polar code, and the second communication device may be configured to receive the encoded bits from the first communication device, and to decode the encoded bits to obtain decoded input bits. As in other embodiments, the polar code may comprise bit indices for placing values of input bits before encoding, and the bit indices may comprise: a first set of bit indices for placing values of a first subset of the input bits, a second set of bit indices for placing values of a second subset of the input bits, and a third set of bit indices for a predetermined bit value. Each value of the first subset of the input bits would have been placed on one bit index of the first set of bit indices, and each value of the second subset of the input bits would have been placed on two or more bit indices of the second set of bit indices.

The first communication device in a system may also or instead implement, provide, or support other encode-side or transmit-side features disclosed herein, and similarly the second communication device in a system may also or instead implement, provide, or support other decode-side or receive-side features disclosed herein.

More generally, other features disclosed herein may also or instead be provided in method, apparatus, and/or system embodiments.

Embodiments disclosed herein encompass various aspects of polar coding, including encoding and decoding.

Disclosed embodiments may provide a fundamental upgrade of polar codes, and may make polar codes applicable for a much wider set of scenarios.

For example, disclosed embodiments may be implemented as part of a channel coding scheme, and may thus be applicable wherever channel coding is used. This covers a very wide range of scenarios. The flexibility provided by embodiments disclosed herein may help make the associated channel coding scheme particularly suitable for wireless communications.

Possible product deployments, in or in conjunction with which embodiments may be implemented, include network devices such as base stations, access devices such as UEs, robots, sensors, cars, drones, and satellites. Service deployment examples include enhanced mobile broadband (eMBB), ultra-reliable low latency communications (URLLC), massive machine type communications (mMTC)/Internet of things (IoT), and vehicular and industry scenarios. Network deployment examples include 5G+, 6G, WiFi, non-terrestrial networks (NTNs), optical networks, distributed networks, and self-organized networks. These are illustrative and non-limiting examples, and other deployments, implementations, or applications are possible.

Potential advantages of embodiments disclosed herein include larger design space and more flexible definition of polar codes and coupled/nested polar codes. Embodiments may also or instead allow any bit value to be placed on multiple bit indices and provide for concise representations of such bit value placement. Placing input bit values on multiple bit indices as disclosed herein may also help provide or enhance self-decodability by placing input bit values, instead of a predetermined value for frozen bits for example, on more bit indices. Various options bit placement, including label assigning rules in some embodiments, may help avoid catastrophic performance loss and/or enhance performance.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of method embodiments, for example, may also or instead be implemented in apparatus or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Although aspects of the present invention have been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

1. A method comprising:
encoding input bits by a polar code to obtain encoded bits, the polar code comprising a plurality of bit indices for placing values of the input bits before the encoding, the bit indices comprising: a first set of bit indices for placing first values of a first subset of the input bits, a second set of bit indices for placing second values of a second subset of the input bits, and a third set of bit indices for placing a predetermined bit value,
wherein each value of the first subset of the input bits is placed on respective one bit index of the first set of bit indices, and each value of the second subset of the input bits is placed on respective two or more bit indices of the second set of bit indices; and
outputting the encoded bits.

2. The method of claim 1, wherein each value of the second subset of the input bits that is placed on the respective two or more bit indices of the second set enables an input bit value to be known for all of the respective two or more bit indices after the input bit value is decoded for any one of the respective two or more bit indices.

3. The method of claim 1, wherein the plurality of bit indices is associated with a plurality of code blocks, and wherein the second set of bit indices comprises bit indices associated with multiple code blocks of the plurality of code blocks.

4. The method of claim 1, wherein the values of the input bits are recursively divided, in multiple iterations, among a plurality of code blocks, and wherein the plurality of code blocks at each iteration comprise a shorter code block that includes all input bit values of a longer code block from which the shorter code block is divided at the each iteration.

5. The method of claim 1, wherein the encoding comprises:
assigning the values of the input bits and the predetermined bit value to respective labels that are associated with the plurality of bit indices; and
assigning the values of the input bits and the predetermined bit value of the respective labels to the plurality of bit indices, wherein the respective labels comprise a subset of labels associated with the second set of bit indices for assigning each respective value of the second subset of the input bits to the respective two or more bit indices of the second set of bit indices.

6. A method comprising:
receiving encoded bits that have been encoded by a polar code, the polar code comprising a plurality of bit indices for placing values of input bits before encoding, the bit indices comprising: a first set of bit indices for placing values of a first subset of the input bits, a second set of bit indices for placing values of a second subset of the input bits, and a third set of bit indices for a predetermined bit value,
each value of the first subset of the input bits having been placed on respective one bit index of the first set of bit indices, and each value of the second subset of the input bits having been placed on respective two or more bit indices of the second set of bit indices; and
decoding the encoded bits to obtain decoded input bits.

7. The method of claim 6, wherein the decoding comprises:
for each value of the second subset of the input bits that is placed on the respective two or more bit indices, decoding an input bit value for any one of the respective two or more bit indices.

8. The method of claim 6, wherein the plurality of bit indices is associated with a plurality of code blocks, and wherein the second set of bit indices comprises bit indices associated with multiple code blocks of the plurality of code blocks.

9. The method of claim 6, wherein the values of the input bits have been recursively divided, in multiple iterations, among a plurality of code blocks, and wherein the plurality of code blocks at each iteration comprised a shorter code block that included all input bit values of a longer code block from which the shorter code block was divided at the each iteration.

10. The method of claim 6, wherein respective labels are associated with the plurality of bit indices, the values of the input bits and the predetermined bit value having been placed on the plurality of bit indices by assigning the values of the input bits and the predetermined bit value to the respective labels, and assigning the values of the input bits and the predetermined bit value of the respective labels to the plurality of bit indices, and wherein the respective labels comprise a subset of labels associated with the second set of bit indices for assigning each respective value of the second subset of the input bits to the respective two or more bit indices of the second set of bit indices.

11. An apparatus comprising:
an encoder configured to encode input bits by a polar code to obtain encoded bits, the polar code comprising a plurality of bit indices for placing values of the input bits before encoding, the bit indices comprising: a first set of bit indices for placing values of a first subset of the input bits, a second set of bit indices for placing values of a second subset of the input bits, and a third set of bit indices for placing a predetermined bit value,
wherein each value of the first subset of the input bits is placed on respective one bit index of the first set of bit indices, and each value of the second subset of the input bits is placed on respective two or more bit indices of the second set of bit indices; and
an interface coupled to the encoder, configured to output the encoded bits.

12. The apparatus of claim 11, wherein each value of the second subset of the input bits that is placed on the respective two or more bit indices of the second set enables an input bit value to be known for all of the respective two or more bit indices after the input bit value is decoded for any one of the respective two or more bit indices.

13. The apparatus of claim 11, wherein the plurality of bit indices is associated with a plurality of code blocks, and wherein the second set of bit indices comprises bit indices associated with multiple code blocks of the plurality of code blocks.

14. The apparatus of claim 11, wherein the values of the input bits are recursively divided, in multiple iterations, among a plurality of code blocks, and wherein the plurality of code blocks at each iteration comprise a shorter code block that includes all input bit values of a longer code block from which the shorter code block is divided at the each iteration.

15. The apparatus of claim 11, wherein the encoder is configured to encode the input bits by:
assigning the values of the input bits and the predetermined bit value to respective labels that are associated with the plurality of bit indices; and
assigning the values of the input bits and the predetermined bit value of the respective labels to the plurality of bit indices, wherein the respective labels comprise a subset of labels associated with the second set of bit indices for assigning each respective value of the second subset of the input bits to the respective two or more bit indices of the second set of bit indices.

16. An apparatus comprising:
an interface configured to receive encoded bits that have been encoded by a polar code, the polar code comprising a plurality of bit indices for placing values of input bits before encoding, the bit indices comprising: a first set of bit indices for placing values of a first subset of the input bits, a second set of bit indices for placing values of a second subset of the input bits, and a third set of bit indices for a predetermined bit value,
each value of the first subset of the input bits having been placed on respective one bit index of the first set of bit indices, and each value of the second subset of the input bits having been placed on respective two or more bit indices of the second set of bit indices; and
a decoder coupled to the interface, configured to decode the encoded bits to obtain decoded input bits.

17. The apparatus of claim 16, wherein the decoder is configured to:
for each value of the second subset of the input bits that is placed on the respective two or more bit indices, decode an input bit value for any one of the respective two or more bit indices.

18. The apparatus of claim 16, wherein the plurality of bit indices is associated with a plurality of code blocks, and wherein the second set of bit indices comprises bit indices associated with multiple code blocks of the plurality of code blocks.

19. The apparatus of claim 16, wherein the values of the input bits have been recursively divided, in multiple iterations, among a plurality of code blocks, and wherein the plurality of code blocks at each iteration comprised a shorter code block that included all input bit values of a longer code block from which the shorter code block was divided at the each iteration.

20. The apparatus of claim 16, wherein respective labels are associated with the plurality of bit indices, the values of the input bits and the predetermined bit value having been placed on the plurality of bit indices by assigning the values of the input bits and the predetermined bit value to the respective labels, and assigning the values of the input bits and the predetermined bit value of the respective labels to the plurality of bit indices, and wherein the respective labels comprise a subset of labels associated with the second set of bit indices for assigning each respective value of the second subset of the input bits to the respective two or more bit indices of the second set of bit indices.
